(19) United States
(12) Patent Application Publication
(10) Pub. No.: US 2005/0219523 A1
(43) Pub. Date: Oct. 6, 2005

(54) Foreign matter detecting system

(75) Inventors: Chieko Onuma, Tokyo (JP); Mitsuji Ikeda, Tokyo (JP); Noriko Ilzumi, Hitachinaka-shi (JP); Jun Maeda, Hitachinaka-shi (JP); Takashi Matsuyama, Kyoto-shi (JP)

Correspondence Address: CROWELL & MORING LLP;INTELLECTUAL PROPERTY GROUP, P.O. BOX 14300, WASHINGTON, DC, 20044-4300, US

(73) Assignee: Hitachi, Ltd., Tokyo (JP)

(21) Appl. No.: 11/060,499

(22) Filed: Feb. 18, 2005

(30) Foreign Application Priority Data
Mar. 31, 2004 (JP) 2004-101795

(51) Int. Cl. G01N 21/88

(52) U.S. Cl. 356/239.5

(57) ABSTRACT

A foreign matter detecting system which can acquire a clear image and detect a foreign matter with high accuracy based on the acquired image regardless of whether a subject is located far or near from an image capturing device in spite of a depth variation or a level difference. An image capturing unit having an externally controllable focus position is disposed above or below a liquid surface, and a ray of light from an LED is illuminated toward the liquid surface from above or the side at least at a focus position of the image capturing unit so that a foreign matter on the liquid surface causes mirror reflection. The focus position of the image capturing unit is changed over the range from the top of a container containing a liquid to the bottom thereof. At each focus position, an input image from the image capturing unit is taken into an image input unit of an image processing section. An image selecting unit of the image processing section selects an image focused on the liquid surface or a clearest image of the liquid surface from among the input images. An image detecting unit of the image processing section checks the presence and position of the mirror reflection, thereby detecting the foreign matter.

### BACKGROUND OF THE INVENTION

1. Field of the Invention

The present invention relates to a system for illuminating a ray of light toward surfaces to be examined, to thereby examine the surfaces of liquid materials, such as pharmaceuticals and beverages, and/or detect the presence of foreign matters or bubbles in the liquid materials, the presence of surface detects, etc. from a ray of reflected light obtained with mirror reflection.

2. Description of the Related Art

As known foreign matter detection methods, there are a method of illuminating a ray of light having varying intensity toward a surface to be examined and checking the presence of mirror reflection, thereby detecting a surface defect (Patent Reference 1; Japanese Patent No. 3062293), and a method of illuminating multiple rays of parallel light toward a liquid surface in a rotating container while moving an illumination position and a camera following the rotating target, and checking the presence of reflected light from a foreign matter, thereby detecting the presence of a floating material (Patent Reference 2; JP,A 2002-357560).

Further, known proximity photographing with an auto-focus camera has a problem that, because focusing is made on an edge, a liquid surface hardly having edges is difficult to establish the focusing.

### SUMMARY OF THE INVENTION

The method disclosed in Patent Reference 1 changes just the intensity of the illuminated light, and therefore it cannot detect such a material defect as causing a level difference or a depth variation in the subject to be examined with respect to an image capturing device.

Also, with the method disclosed in Patent Reference 2, the illumination position and the camera are moved to follow the rotating target. However, when there is a level difference or a depth variation in the subject to be examined with respect to the image capturing device, it is impossible to detect a foreign matter because a clear in-focus image cannot be obtained.

Accordingly, it is an object of the present invention to provide a foreign matter detecting system which, when capturing an image of a subject in any light or dark place, can acquire a clear image regardless of whether the subject is located far or near from an image capturing device in spite of a depth variation or a level difference, i.e., the magnitude of a variation in the depth-of-field direction, and can detect a foreign matter or a bubble with high accuracy based on the acquired image.

To achieve the above object, a foreign matter detecting system according to one aspect of the present invention comprises a container capable of containing a liquid; an image capturing unit disposed above the container and capable of capturing an image while changing a focus position; a light source for emitting a ray of light to illuminate the focus position of the image capturing unit; and an image processing unit for executing image capturing control of the image capturing unit and illumination control of the light source, wherein the image capturing unit captures an image while changing the focus position with respect to the liquid in the container, and the image processing unit takes in, from the image capturing unit, image data of a liquid surface at the focus position of the image capturing unit under illumination by the light source, and detects the presence of a foreign matter in the liquid based on the taken-in image data.

In the foreign matter detecting system of the present invention, preferably, the light source is disposed laterally of the container.

In the foreign matter detecting system of the present invention, preferably, the light source is disposed in plural over a range from the top to bottom of the container therealong.

In the foreign matter detecting system of the present invention, preferably, the light source comprises plural groups each including a plurality of light sources disposed over a range from the top to bottom of the container therealong, and the light source groups are disposed to illuminate the container from different positions.

In the foreign matter detecting system of the present invention, preferably, the image capturing unit includes a polarizing filter disposed in front of the image capturing unit and a polarizing filter rotating unit for rotating the polarizing filter.

The foreign matter detecting system of the present invention preferably further comprises, other than the image capturing unit, a unit for detecting a position of the liquid surface in the container.

In the foreign matter detecting system of the present invention, preferably, the light source is disposed above the container.

In the foreign matter detecting system of the present invention, preferably, the light source is disposed in plural, and the plurality of light sources are disposed at different positions from one another and illuminate the liquid surface in the container from the respective different positions.

In the foreign matter detecting system of the present invention, preferably, the image processing unit determines based on the taken-in image data whether the foreign matter in the container is a three-dimensional object or not.

In the foreign matter detecting system of the present invention, preferably, the image processing unit has a terminal for outputting a focus control signal to the image capturing unit, a terminal for outputting an illumination control signal to the light source, and a terminal for taking in the image data from the image capturing unit.

In the foreign matter detecting system of the present invention, preferably, the system further comprises a container moving unit capable of moving the container, and the image capturing unit acquires the image data on condition that the container is moved by the container moving unit away from or closer to the image capturing unit, while the focus position of the image capturing unit is kept fixed.

In the foreign matter detecting system of the present invention, preferably, the system further comprises an image-capturing-unit moving unit capable of moving the image capturing unit, and the image capturing unit captures the image at the focus position that is changed by moving a position of the image capturing unit away from or closer to the container by the image-capturing-unit moving unit.

In the foreign matter detecting system of the present invention, preferably, the image processing unit includes an image failure checking unit for detecting whether the taken-in image data is normal or abnormal.

In the foreign matter detecting system of the present invention, preferably, the light source is an LED.

In the foreign matter detecting system of the present invention, preferably, the image processing unit has a terminal for outputting the image data taken in from the image capturing unit on a display.

Further, to achieve the above object, a foreign matter detecting system according to another aspect of the present invention comprises a container capable of containing a liquid; an image capturing unit disposed above the container and capable of capturing an image while changing a focus position; a light source for emitting a ray of light to illuminate the focus position of the image capturing unit; and an image processing unit for executing image capturing control of the image capturing unit and illumination control of the light source, wherein the light source is disposed below the container, the image capturing unit captures an image while changing the focus position with respect to the liquid in the container, and the image processing unit takes in, from the image capturing unit, image data of a liquid surface at the focus position of the image capturing unit under illumination by the light source from below the container, and detects the presence of a foreign matter in the liquid based on the taken-in image data.

In the foreign matter detecting system according to another aspect of the present invention, preferably, the light source is an LED.

In the foreign matter detecting system according to another aspect of the present invention, preferably, the image processing unit has a terminal for outputting a focus control signal to the image capturing unit, a terminal for outputting an illumination control signal to the light source, and a terminal for taking in the image data from the image capturing unit.

In the foreign matter detecting system according to another aspect of the present invention, preferably, the image processing unit has a terminal for outputting the image data taken in from the image capturing unit on a display.

According to the present invention, when capturing an image of a subject in any light or dark place, it is possible to acquire a clear image regardless of whether the subject is located far or near from an image capturing device in spite of a depth variation or a level difference, i.e., the magnitude of a variation in the depth-of-field direction, and to detect a foreign matter or a bubble with high accuracy based on the acquired image.

### BRIEF DESCRIPTION OF THE DRAWINGS

FIG. 1 is an explanatory view of a foreign matter detecting system according to one embodiment of the present invention;

FIG. 2 is an explanatory view of a foreign matter detecting system according to another embodiment of the present invention;

FIG. 3 is an explanatory view of a foreign matter detecting system according to still another embodiment of the present invention;

FIG. 4 is an explanatory view for explaining an exemplified manner of capturing images in a basic illumination direction and a control illumination direction by an image capturing unit in the present invention;

FIG. 5 is an explanatory view of a foreign matter detecting system according to still another embodiment of the present invention;

FIG. 6 is an explanatory view of a foreign matter detecting system according to still another embodiment of the present invention;

FIG. 7 is an explanatory view showing a position of mirror reflection caused by a foreign matter for illumination in one illumination direction;

FIG. 8 is an explanatory view showing a position of mirror reflection caused by a foreign matter for illumination in another illumination direction;

FIG. 9 is an explanatory view showing a position of mirror reflection caused by a foreign matter for illumination in still another illumination direction;

FIG. 10 is an explanatory view of a foreign matter detecting system according to still another embodiment of the present invention;

FIG. 11 is a block diagram of an image processing section according to one embodiment of the present invention;

FIG. 12 is a block diagram of an image processing section according to another embodiment of the present invention;

FIG. 13 is a block diagram of a camera control section according to one embodiment of the present invention;

FIG. 14 is a block diagram of an illumination control section according to one embodiment of the present invention;

FIG. 15 is a flowchart of a detection processing procedure executed in the foreign matter detecting system according to one embodiment of the present invention;

FIG. 16 is a flowchart of a detection processing procedure executed in the foreign matter detecting system according to another embodiment of the present invention;

FIG. 17 is a flowchart of a detection processing procedure executed in the foreign matter detecting system according to still another embodiment of the present invention;

FIG. 18 is a flowchart of a detection processing procedure executed in the foreign matter detecting system according to still another embodiment of the present invention;

FIG. 19 is a flowchart of a detection processing procedure executed in the foreign matter detecting system according to still another embodiment of the present invention;

FIG. 20 is an explanatory view of a foreign matter detecting system according to still another embodiment of the present invention;

FIG. 21 is an explanatory view of a foreign matter detecting system according to still another embodiment of the present invention;

FIG. 22 is a flowchart of a detection processing procedure executed in the foreign matter detecting system according to still another embodiment of the present invention;

FIG. 23 is a flowchart of a detection processing procedure executed in the foreign matter detecting system according to still another embodiment of the present invention;

FIG. 24 is an explanatory view of a foreign matter detecting system according to still another embodiment of the present invention;

FIG. 25 is a block diagram of an image processing section according to still another embodiment of the present invention;

FIG. 26 is a block diagram of an image processing section according to still another embodiment of the present invention;

FIG. 27 is a flowchart of a detection processing procedure executed in the foreign matter detecting system according to still another embodiment of the present invention; and

FIG. 28 is an explanatory view of a foreign matter detecting system according to still another embodiment of the present invention.

### DESCRIPTION OF THE PREFERRED EMBODIMENTS

Embodiments of the present invention will be described below with reference to the drawings.

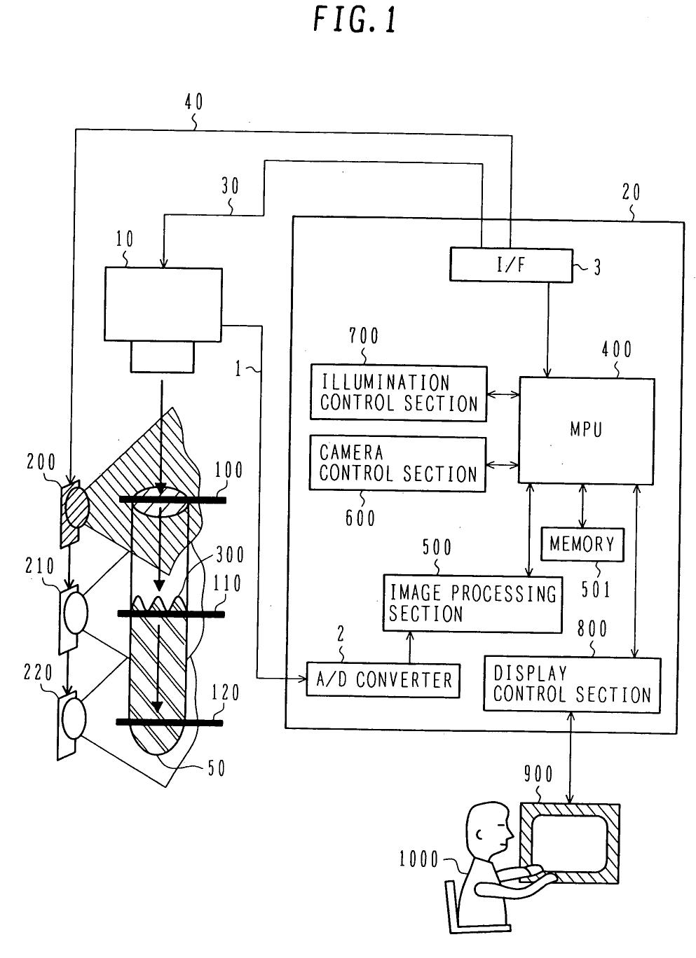

FIG. 1 is an explanatory view of a foreign matter detecting system according to one embodiment of the present invention.

The foreign matter detecting system of this embodiment comprises a container 50 containing a medium (liquid) to be examined, a plurality of light sources (LED's 200, 210 and 220) in this embodiment) disposed laterally of the container 50 and illuminating rays of light, an image capturing unit 10 disposed above the container 50 to be able to capture an image of the medium (liquid) surface to be examined, and an image processor 20 for obtaining captured image data from the image capturing unit 10 and detecting a foreign matter based on the obtained image data.

In the following description, the foreign matter is assumed to include a bubble and so on.

The image capturing unit 10 can externally control a focus position formed in the container 50. When only the LED 200 corresponding to one focus position 100 (i.e., a top surface of the container 50) of the image capturing unit 10 is turned on to illuminate the container 50, the liquid surface is captured as a blurred image if the liquid surface is not present at the focus position 110.

Then, when only the LED 210 is turned on to illuminate another focus position 110 of the image capturing unit 10 laterally of the container 50, the liquid surface is captured as a clear image if the liquid surface is present in match with the focus position 110. In this case, if there is a foreign matter 300 on the liquid surface, the foreign matter 300 causes mirror reflection, and if there is no foreign matter 300 on the liquid surface, mirror reflection does not occur.

Further, when only the LED 220 is turned on to illuminate still another focus position 120 of the image capturing unit 10 laterally of the container 50, the liquid surface is captured as a blurred image if the liquid surface is not present at the focus position 120.

In the above process, control for successively changing the focus position of the image capturing unit 10 over the range from the focus position 100 at the top of the container 50 to the focus position 120 at the bottom thereof is executed through the following steps. An MPU 400 of the image processor 20 outputs a control command to a camera control section 600. In accordance with the control command, the camera control section 600 produces a focus control signal 30, and the produced focus control signal 30 is outputted to a signal line, e.g., an RS-232C line, via an interface (I/F) 3 including a focus control signal output terminal, whereby the focus of the image capturing unit 10 is controlled.

Illumination control of the LED's corresponding to the focus positions 100, 110 and 120 of the image capturing unit 10 is executed through the following steps. The MPU 400 of the image processor 20 outputs a control command to an illumination control section 700, and the illumination control section 700 produces an illumination control signal 40 that is outputted as a parallel signal to the LED's via the interface (I/F) 3 including an illumination control signal output terminal. At each of the focus positions successively changed over the range including the focus positions 100, 110 and 120, a video signal 1 outputted from the image capturing unit 10 is inputted to a video terminal of the image processor 20. The input video signal 1 is converted to a digital image by an A/D converter 2 and then taken into an image processing section 500. From among the video signals 1 thus taken in, the image processing section 500 selects an image in focus with the liquid surface or a clearest image of the liquid surface, and checks the presence and position of mirror reflection based on the selected image, thereby detecting the foreign matter. The image used for detecting the foreign matter is stored in a memory 501, and a display control section 800 displays the desired images and information on a display 900. An operator 1000 displays and searches the stored images and information as required.

While this embodiment employs the LED as the light source, another type of light source can also be used. In other words, any type of light source is usable so long as it is able to quickly illuminate when turned on. From this point of view, the LED is optimum.

According to this embodiment, since the focus position of the image capturing unit is successively changed at least over the range from the focus position at the top of the container, which contains the liquid whose surface is to be examined, to the focus position at the bottom thereof, the following advantages are obtained. Even when the liquid surface in an elongate container varies to a large extent (namely it has a large difference in focal depth) and the liquid is transparent, the liquid under examination can be detected as including a foreign matter and can be excluded from the examination subject regardless of the magnitude of a level difference of the liquid surface to be examined if there is a bubble, an air bubble, dust or the like in the container and/or the liquid surface, or if there is a projection on the liquid surface. Therefore, the detection accuracy of precision instruments, etc. can be prevented from deteriorating due to the presence of an obstacle, such as a foreign matter, and reliability can be improved. In addition, the detecting system can be realized at a relatively low cost.

Also, because of the LED being turned on to illuminate the liquid surface laterally of the container, even when a cover member, such as a barcode, is pasted to a peripheral surface of the container, a bubble, an air bubble, dust or the like in the container can be clearly imaged if the light having passed through the cover member is illuminated into the container.

Further, since the images used for checking the foreign matter are stored in the memory, the desired images and information can be displayed on the display through the display control section, and the operator can display and search the stored images and information as required. It is hence possible to present, as a proof, the image that has been used for determining the detection result. In particular, this embodiment is effective when an image of the subject is to be captured at a short distance in any light or dark place on condition that there occur a level difference or a depth variation (i.e., a variation in the depth-of-field direction).

While this embodiment is described above as using a plurality of light sources, the present invention is not limited to such an arrangement and at least one light source is essential because the present invention just requires the illumination to be applied to the focus position of the image capturing unit. Using one light source is advantageous in simplifying the illumination control section 700. On the other hand, using a plurality of light sources is advantageous that the light source moving or illumination angle control is not required.

Furthermore, this embodiment is described above in connection the case of first turning on only the LED 200, then turning on only the LED 210, and finally turning on only the LED 220. However, the command for illuminating the focus position may be modified such that the MPU 400 of the image processor 20 commands the illumination control section 700 to turn on all the LED's 200, 210 and 220 at the same time. This modification is advantageous in simplifying the illumination control section 700.

Note that the display control section 800 and the display 900 may be constructed of known ordinary devices.

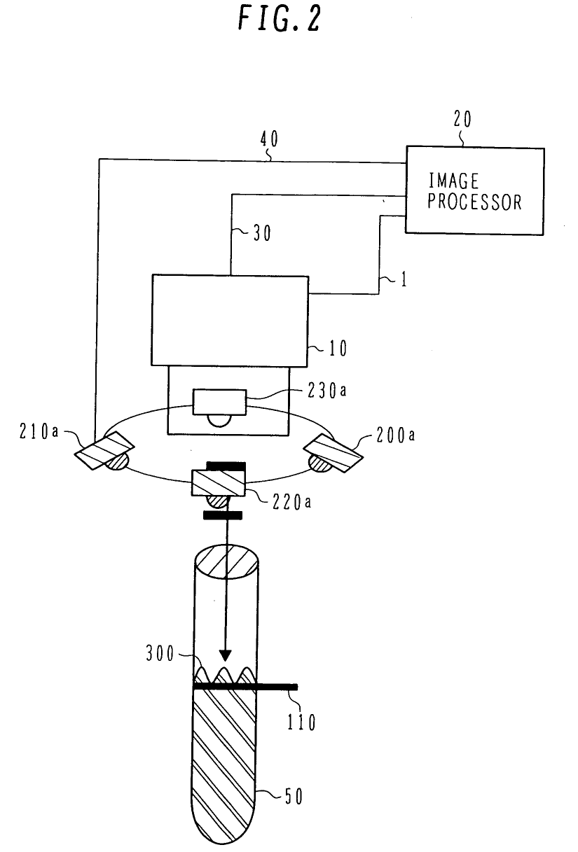

FIG. 2 is an explanatory view of a foreign matter detecting system according to another embodiment of the present invention.

The foreign matter detecting system of this embodiment differs from the system of FIG. 1 in that LED's (light sources) are positioned above the container 50. The other arrangement is the same as that shown in FIG. 1.

The image capturing unit 10 having an externally controllable focus position is disposed above the container 50 to face the liquid surface, and light sources, such as LED's, are disposed to illuminate the liquid surface in the container 50 from above the top of the container 50. Only an LED 200a is first turned on to emit a ray of light in a basic illumination direction and only an LED 220a is then turned on to emit a ray of light in a control illumination direction so that the movement of mirror reflection caused by a foreign matter and the movement of reflection of the light source can be discriminated from each other.

More specifically, only the LED 200a is first turned on and the focus position of the image capturing unit 10 is successively changed at least over the range from the top of the container 50, which contains the liquid whose surface is to be examined, to the bottom thereof in accordance with the focus control signal 30 outputted from the image processor 20. At each focus position, an image is inputted to the image capturing unit 10 and taken into the image processing section 500 of the image processor 20. From among the input images thus taken in, the image processing section 500 selects an image in focus with the liquid surface or a clearest image of the liquid surface (referred to as an “input image a”).

Then, only the LED 220a illuminating the liquid surface in a different direction from the LED 200a is turned on and the focus position of the image capturing unit 10 is successively changed at least over the range from the top of the container 50, which contains the liquid whose surface is to be examined, to the bottom thereof in accordance with the focus control signal 30 outputted from the image processor 20. At each focus position, an image is inputted to the image capturing unit 10 and taken into the image processing section 500 of the image processor 20. From among the input images thus taken in, the image processing section 500 selects an image in focus with the liquid surface or a clearest image of the liquid surface (referred to as an “input image b”). The image processing section 500 checks the presence and position of mirror reflection based on both the input images a and b, thereby detecting the foreign matter. The images used for detecting the foreign matter are stored in the memory, and the display control section 800 displays the desired images and information on the display 900. The operator 1000 displays and searches the stored images and information as required.

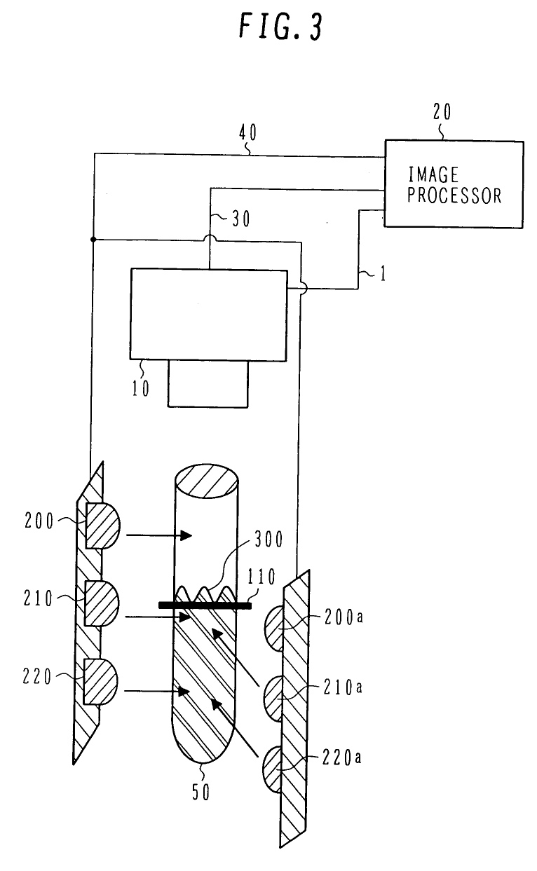

FIG. 3 is an explanatory view of a foreign matter detecting system according to still another embodiment of the present invention.

In the foreign matter detecting system of this embodiment, light sources, such as LED's, are positioned to illuminate the liquid surface sideways like the system of FIG. 1. In the system of FIG. 3, however, two groups of LED light sources (each group comprising three LED's in FIG. 3) are disposed so that the liquid surface can be illuminated from different directions.

The image capturing unit 10 having an externally controllable focus position is disposed above the container 50 to face the liquid surface, and light sources, such as LED's, are disposed to illuminate the liquid surface in the container 50 sideways. In order to illuminate the range from the top to bottom of the container 50, the image processor 20 first commands the illumination control signal 40 to turn on all of LED's 200, 210 and 220 to emit rays of light in a basic illumination direction and then commands the illumination control signal 40 to turn on all of LED's 200a, 210a and 220a to emit rays of light in a control illumination direction so that the movement of mirror reflection caused by a foreign matter and the movement of reflection of the light source can be discriminated from each other.

More specifically, it is here assumed that a direction in which one light source group (LED's 200, 210 and 220) emits rays of light for illumination of the container 50 is the basic illumination direction and a different direction in which the other light source group (LED's 200a, 210a and 220a) emits rays of light for illumination of the container 50 is the control illumination direction. First, the LED's 200, 210 and 220 corresponding to the basic illumination direction are all turned on and the focus position of the image capturing unit 10 is successively changed at least over the range from the top of the container 50, which contains the liquid whose surface is to be examined, to the bottom thereof in accordance with the focus control signal 30 outputted from the image processor 20. At each focus position, an image is inputted to the image capturing unit 10 and taken into the image processing section 500 of the image processor 20. From among the input images thus taken in, the image processing section 500 selects an image in focus with the liquid surface or a clearest image of the liquid surface (referred to as an “input image a”).

Then, the LED's 200a, 210a and 220a corresponding to the control illumination direction are all turned on and the focus position of the image capturing unit 10 is successively changed at least over the range from the top of the container 50, which contains the liquid whose surface is to be examined, to the bottom thereof in accordance with the focus control signal 30 outputted from the image processor 20. At each focus position, an image is inputted to the image capturing unit 10 and taken into the image processing section 500 of the image processor 20. From among the input images thus taken in, the image processing section 500 selects an image in focus with the liquid surface or a clearest image of the liquid surface (referred to as an “input image b”). The image processing section 500 checks the presence and position of mirror reflection based on both the input images a and b, thereby detecting the foreign matter. The images used for detecting the foreign matter are stored in the memory, and the display control section 800 displays the desired images and information on the display 900. The operator 1000 displays and searches the stored images and information as required.

In the case of the illumination shown in FIG. 2, because the ray of light from the light source is directly illuminated to the liquid surface, the light source is reflected on the liquid surface. In this embodiment, however, because the light source, e.g., the LED, illuminates the liquid surface sideways, the ray of light is reflected depending on the refractive index of the container and the light source is not reflected on the liquid surface. A bubble is generated only in or on the liquid surface. Therefore, if reflection of the light source occurs on the liquid surface, it is difficult to discriminate the mirror reflection caused by the bubble and the reflection of the light source from each other. By illuminating the ray of light toward the liquid surface sideways, it is no longer required to discriminate the mirror reflection caused by the bubble and the reflection of the light source from each other, and therefore the discrimination process can be simplified.

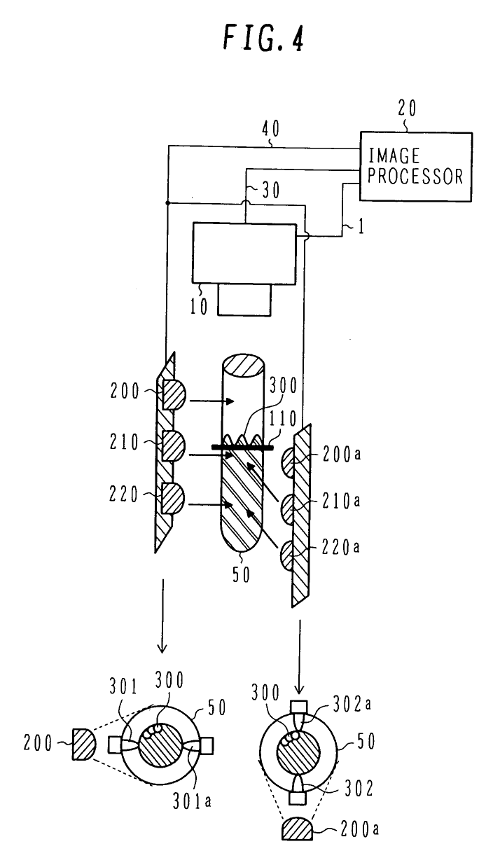

FIG. 4 is an explanatory view for explaining an exemplified manner of capturing images in the basic illumination direction and the control illumination direction by the image capturing unit in the present invention.

Assuming that the liquid surface is present near the position illuminated by the ray of light emitted from the LED 200 in the basic illumination direction and the image capturing unit 10 is focused on the liquid surface, if there is a bubble (foreign matter 300) on the liquid surface inside the container 50, the foreign matter 300 causes mirror reflection.

Because the container 50 is illuminated sideways, the LED 200 in the basic illumination direction (i.e., one illumination direction) generates rays of reflected light (reflection) as reflected light 301 and reflected light 301a laterally of the container 50 depending on the direction of the light source. Here, the light is illuminated while adjusting the illuminated position such that the sideway illumination of the container 50 generates the reflected light 301 and the reflected light 301a as shown.

Also, because the container 50 is illuminated sideways, the LED 200a in the control illumination direction (i.e., the other illumination direction) generates rays of reflected light (reflection) as reflected light 302 and reflected light 302a laterally of the container 50 depending on the direction of the light source. Here, the light is illuminated while adjusting the illuminated position such that the sideway illumination of the container 50 generates the reflected light 302 and the reflected light 302a as shown. On an assumption that the foreign matter is not moved, when the positions of the LED 200 and the LED 200a are angularly shifted 90° from each other, the mirror reflection caused by the foreign matter is shifted at an angle smaller than 90°, while the position where the reflected light 301 generates is shifted 90° from the position where the reflected light 302 generates. Based on the information representing the change in the position where each reflected light generates, it is understood that a large change corresponds to the reflected light of the LED illumination and a small change corresponds to the mirror reflection caused by the foreign matter. Accordingly, this embodiment is effective in making easier the discrimination between the reflected light of the LED illumination and the mirror reflection caused by the foreign matter, and in improving the detection performance.

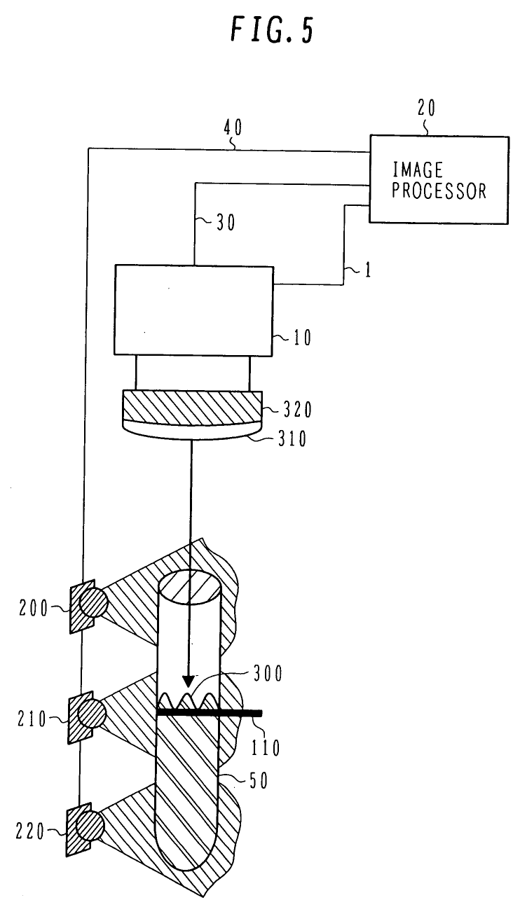

FIG. 5 is an explanatory view of a foreign matter detecting system according to still another embodiment of the present invention.

In the foreign matter detecting system of this embodiment, light sources, such as LED's, are positioned to illuminate the liquid surface sideways like the system of FIG. 1. In the system of FIG. 5, however, a polarizing filter rotating device 320 and a polarizing filter 310 are disposed in front of the image capturing unit 10.

The image capturing unit 10 having an externally controllable focus position is disposed above the container 50 to face the liquid surface, and a light source, e.g., an LED, emits a ray of light to illuminate the liquid surface in the container 50 sideways. The polarizing filter rotating device 320 and the polarizing filter 310 are mounted so as to position in front of the image capturing unit 10 in parallel. The LED's 200, 210 and 220 are all turned on to illuminate the container 50 sideways. The focus position of the image capturing unit 10 is successively changed at least over the range from the top of the container 50, which contains the liquid whose surface is to be examined, to the bottom thereof.

More specifically, the polarizing filter 310 is first disposed to orient in one basic position (basic mount position), following which the LED's 200, 210 and 220 are turned on for illumination of the container 50. The focus position of the image capturing unit 10 is successively changed at least over the range from the top of the container 50, which contains the liquid whose surface is to be examined, to the bottom thereof in accordance with the focus control signal 30 outputted from the image processor 20. At each focus position, an image is inputted to the image capturing unit 10 and taken into the image processing section 500 of the image processor 20. From among the input images thus taken in, the image processing section 500 selects an image in focus with the liquid surface or a clearest image of the liquid surface (referred to as an “input image a through the polarizing filter”).

Then, the polarizing filter 310 is rotated by the polarizing filter rotating device 320 in front of the image capturing unit 10 in parallel so as to orient in the other position (control mount position) in order that the mirror reflection caused by the foreign matter and the reflection of the light source can be discriminated from each other. In such a state, the LED's 200, 210 and 220 are turned on for illumination of the container 50. The focus position of the image capturing unit 10 is successively changed at least over the range from the top of the container 50, which contains the liquid whose surface is to be examined, to the bottom thereof in accordance with the focus control signal 30 outputted from the image processor 20. At each focus position, an image is inputted to the image capturing unit 10 and taken into the image processing section 500 of the image processor 20. From among the input images thus taken in, the image processing section 500 selects an image in focus with the liquid surface or a clearest image of the liquid surface (referred to as an “input image b through the polarizing filter”).

The image processing section 500 checks the presence and position of mirror reflection based on both the input image a through the polarizing filter and the input image b through the polarizing filter, thereby detecting the foreign matter. The images used for detecting the foreign matter are stored in the memory, and the display control section 800 displays the desired images and information on the display 900. The operator 1000 displays and searches the stored images and information as required.

The oscillation direction of light in an ordinary state is perpendicular to the direction in which the light advances, and is at random in a plane perpendicular to the advance direction. When such light impinges upon a flat surface of a non-metallic material, such as glass or plastic, at a particular angle and is reflected from it, the reflected light becomes light polarized to oscillate only in one direction (i.e., polarized light). Only the reflected light from the non-metallic surface is subjected to polarization, and neither light having passed through glass nor reflected light from a metallic surface causes a polarization phenomenon. A polarizing filter (PL filter) has a structure having a special film, called a “polarizing film”, sandwiched between two sheets of glass, to thereby allow passage of both the light having a particular polarization direction and the light having no polarization characteristics through it. Accordingly, by arranging the PL filter such that the polarization direction of the filter is angularly shifted 90° with respect to the polarization direction of the polarized light reflected from the glass surface, only the reflected light from the glass surface can be cut off, while the light having no polarization characteristics and the light having the same polarization direction as the PL filter are both allowed to pass through the filter as they are.

It is thus understood that, with the provision of the polarizing filter 310 rotated by the polarizing filter rotating device 320, the detected light is the reflected light (reflection) of the light source when it is present in an image captured through the polarizing filter 310 oriented in the basic mount position, but it is not present in an image captured through the polarizing filter 310 rotated by the polarizing filter rotating device 320 so as to orient in the control mount position angularly shifted 90° from the basic mount position, and the detected light represents the mirror reflection caused by the foreign matter when it is present in both the images. As a result, this embodiment is effective in simplifying the determination process.

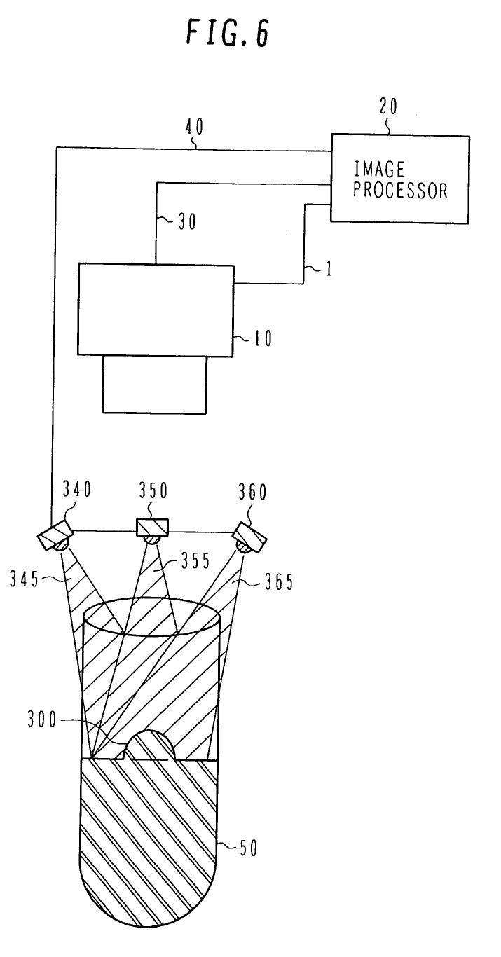

FIG. 6 is an explanatory view of a foreign matter detecting system according to still another embodiment of the present invention.

In the foreign matter detecting system of this embodiment, as in the system of FIG. 2, light sources are installed above the container 50 to illuminate the container 50 from above. As shown in FIG. 6, a plurality of light sources are disposed side by side to lie in a substantially horizontal direction with respect to the liquid surface in the container 50 and emit rays of light to illuminate the liquid surface from different positions so that whether a foreign matter is a three-dimensional object or not can be determined.

The plurality of light sources, e.g., LED's, are arranged such that a foreign matter to be detected causes mirror reflection in different positions when it receives the rays of light from the light sources. The image capturing unit 10 having an externally controllable focus position is disposed above the container 50 to face the liquid surface, and three light sources, i.e., an LED 340 corresponding to one illumination direction A, an LED 350 corresponding to another illumination direction B, and an LED 360 corresponding to one illumination direction C, emit rays of light to illuminate the liquid surface in the container 50 from above the top of the container 50 so that whether a foreign matter is a three-dimensional object or not can be determined from position change of the mirror reflection. The focus position of the image capturing unit 10 is successively changed at least over the range from the top of the container 50, which contains the liquid whose surface is to be examined, to the bottom thereof.

More specifically, only the LED 340 corresponding to the illumination direction A is first turned on and the focus position of the image capturing unit 10 is successively changed at least over the range from the top of the container 50, which contains the liquid whose surface is to be examined, to the bottom thereof in accordance with the focus control signal 30 outputted from the image processor 20. At each focus position, an image is inputted to the image capturing unit 10 and taken into the image processing section 500 of the image processor 20. From among the input images thus taken in, the image processing section 500 selects an image in focus with the liquid surface or a clearest image of the liquid surface (referred to as an “input image in the illumination direction A”).

Then, only the LED 350 corresponding to the illumination direction B is turned on and the focus position of the image capturing unit 10 is successively changed at least over the range from the top of the container 50, which contains the liquid whose surface is to be examined, to the bottom thereof in accordance with the focus control signal 30 outputted from the image processor 20. At each focus position, an image is inputted to the image capturing unit 10 and taken into the image processing section 500 of the image processor 20. From among the input images thus taken in, the image processing section 500 selects an image in focus with the liquid surface or a clearest image of the liquid surface (referred to as an “input image in the illumination direction B”).

Further, only the LED 360 corresponding to the illumination direction C is turned on and the focus position of the image capturing unit 10 is successively changed at least over the range from the top of the container 50, which contains the liquid whose surface is to be examined, to the bottom thereof in accordance with the focus control signal 30 outputted from the image processor 20. At each focus position, an image is inputted to the image capturing unit 10 and taken into the image processing section 500 of the image processor 20. From among the input images thus taken in, the image processing section 500 selects an image in focus with the liquid surface or a clearest image of the liquid surface (referred to as an “input image in the illumination direction C”). The image processing section 500 checks the presence and position of mirror reflection based on the input image in the illumination direction A, the input image in the illumination direction B and the input image in the illumination direction C, thereby detecting the foreign matter. The images used for detecting the foreign matter are stored in the memory, and the display control section 800 displays the desired images and information on the display 900. The operator 1000 displays and searches the stored images and information as required.

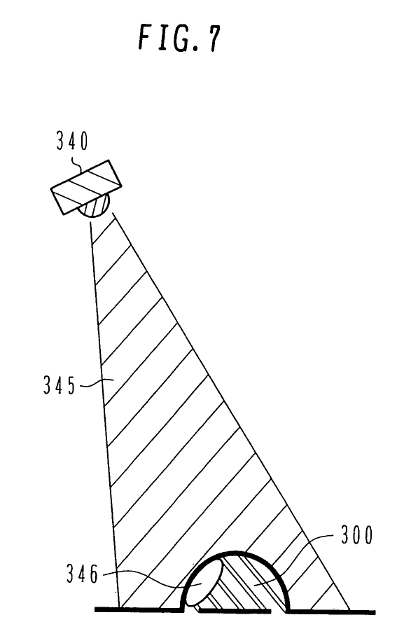

FIGS. 7 to 9 are explanatory views for explaining the relationship between the illumination direction from the light source toward the liquid surface and the mirror reflection occurred on the liquid surface in the system of FIG. 6.

More specifically, FIG. 7 is an explanatory view showing a position of mirror reflection 346 caused by a foreign matter 300 for the illumination in the illumination direction A. Because a ray of light 345 from the LED 340 corresponding to the illumination direction A is illuminated from an upper left position as shown, the mirror reflection 346 occurs in an upper left area of the projected surface of the foreign matter 300.

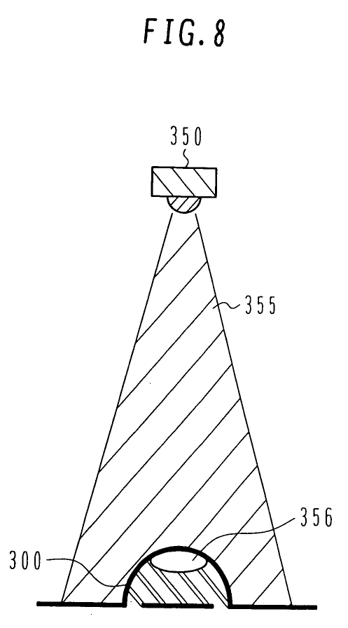

FIG. 8 is an explanatory view showing a position of mirror reflection 356 caused by a foreign matter 300 for the illumination in the illumination direction B. Because a ray of light 355 from the LED 350 corresponding to the illumination direction B is illuminated from a just above position as shown, the mirror reflection 356 occurs in an upper central area of the projected surface of the foreign matter 300.

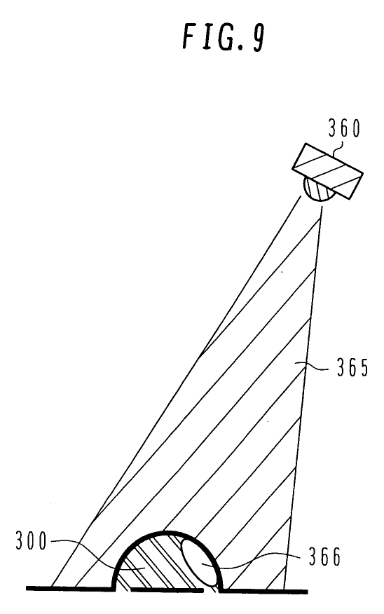

FIG. 9 is an explanatory view showing a position of mirror reflection 366 caused by a foreign matter 300 for the illumination in the illumination direction C. Because a ray of light 365 from the LED 360 corresponding to the illumination direction C is illuminated from an upper right position as shown, the mirror reflection 366 occurs in an upper right of the projected surface of the foreign matter 300.

In the case of the foreign matter 300 being present, since the foreign matter forms a projection on the liquid surface, the mirror reflection 346 caused by the foreign matter for the illumination from the LED 340 corresponding to the illumination direction A, the mirror reflection 356 caused by the foreign matter for the illumination from the LED 350 corresponding to the illumination direction B, and the mirror reflection 366 caused by the foreign matter for the illumination from the LED 360 corresponding to the illumination direction C occur in different positions from one another. It is hence confirmed that the foreign matter is a three-dimensional object.

In the case of the foreign matter 300 being absent, since there is no projection on the liquid surface, the mirror reflection 346 caused by the foreign matter for the illumination from the LED 340 corresponding to the illumination direction A, the mirror reflection 356 caused by the foreign matter for the illumination from the LED 350 corresponding to the illumination direction B, and the mirror reflection 366 caused by the foreign matter for the illumination from the LED 360 corresponding to the illumination direction C occur substantially in the same position. It is hence confirmed that the foreign matter is not a three-dimensional object.

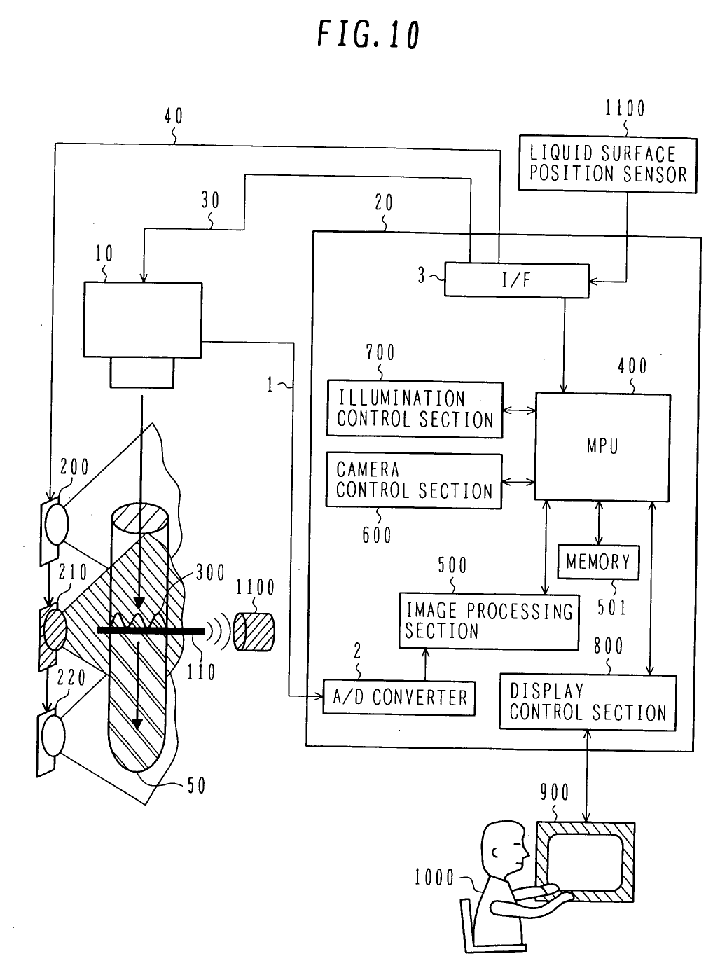

FIG. 10 is an explanatory view of a foreign matter detecting system according to still another embodiment of the present invention.

In the foreign matter detecting system of this embodiment, as in the system of FIG. 1, light sources, e.g., LED's, are disposed to illuminate the container 50 sideways. As shown in FIG. 10, however, this embodiment includes, in addition to the image capturing unit 10, a means for detecting the position of the liquid surface by using an ultrasonic wave.

The image capturing unit 10 having an externally controllable focus position is disposed above the container 50 to face the liquid surface, and the position of the liquid surface is detected by a position sensor 1100 (using, e.g., an ultrasonic wave) other than the image capturing unit 10. The MPU 400 of the image processor 20 outputs a control command to the illumination control section 700, and the illumination control signal 40 is outputted to make control such that only the LED 210 is turned on to illuminate the position of the liquid surface sideways which is detected by the position sensor 1100. Also, the MPU 400 of the image processor 20 outputs a control command to the camera control section 600, and the focus control signal 30 is outputted to make control such that the image capturing unit 10 is focused, as indicated by 110, on the position of the liquid surface which is detected by the position sensor 1100 other than the image capturing unit 10.

If the foreign matter 300 is present on the liquid surface, it causes the mirror reflection, and if the foreign matter 300 is not present on the liquid surface, no mirror reflection occurs. An image of the liquid surface is inputted to the image capturing unit 10 and taken into the image processing section 500 of the image processor 20. The image processing section 500 checks the presence and position of mirror reflection based on the input image thus taken in, thereby detecting the foreign matter. The image used for detecting the foreign matter is stored in the memory, and the display control section 800 displays the desired images and information on the display 900. The operator 1000 displays and searches the stored images and information as required.

This embodiment is advantageous in that, because the camera control section controls the image capturing unit 10 to be focused on the position of the liquid surface, which is detected by the position sensor other than the image capturing unit 10, regardless of variation in level of the liquid surface, the captured image is always an in-focus image and the clearest image of the liquid surface can be obtained with one shot.

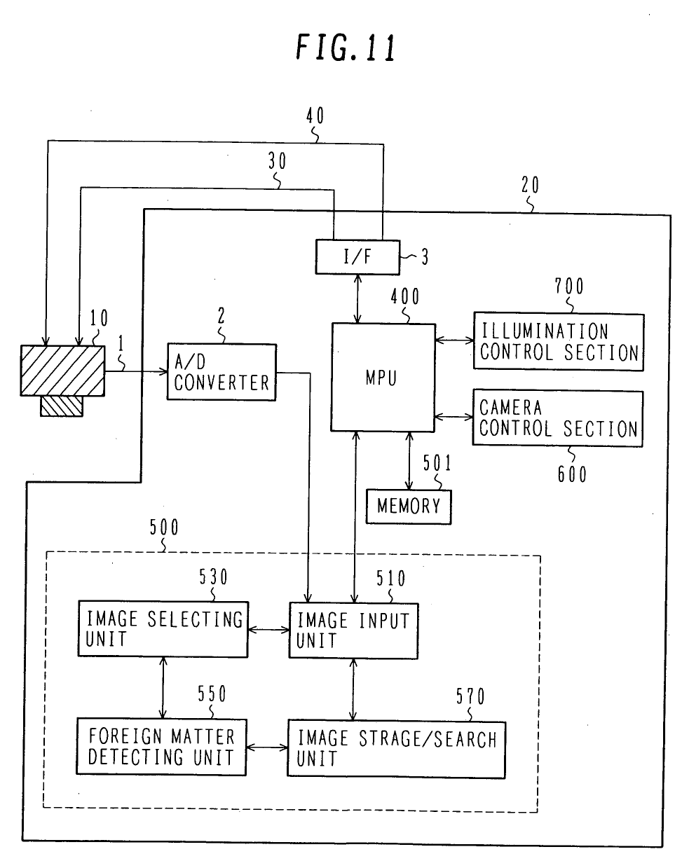

FIG. 11 is a block diagram of the image processing section 500 of the image processor 20 according to one embodiment of the present invention. When the MPU 400 issues an image taking-in command, an image input unit 510 outputs the focus control signal 30 from the camera control section 600 through the I/F 3. The image capturing unit 10 is focused in accordance with the focus control signal 30 to capture an image at each focus position, and outputs a video signal 1. The video signal 1 outputted from the image capturing unit 10 is applied to the video terminal of the image processor 20 and is converted to a digital image by an A/D converter 2, followed by being taken into the image processing section 500. From among the images thus taken in at the respective focus positions, an image selecting unit 530 selects an image in focus with the liquid surface or a clearest image of the liquid surface. Then, a foreign matter detecting unit 550 checks the presence and position of mirror reflection based on data of the selected image, thereby detecting the foreign matter. An image storage/search unit 570 stores, in the memory 501, the image data used by the foreign matter detecting unit 550 for checking the foreign matter.

In response to a request from the operator 1000, the MPU 400 commands the display control section 800 to display the desired images and information stored in the memory 501, whereupon the display control section 800 displays it on the display 900. Thus, the operator 1000 is able to confirm and search for the desired images and information on the screen of the display 900.

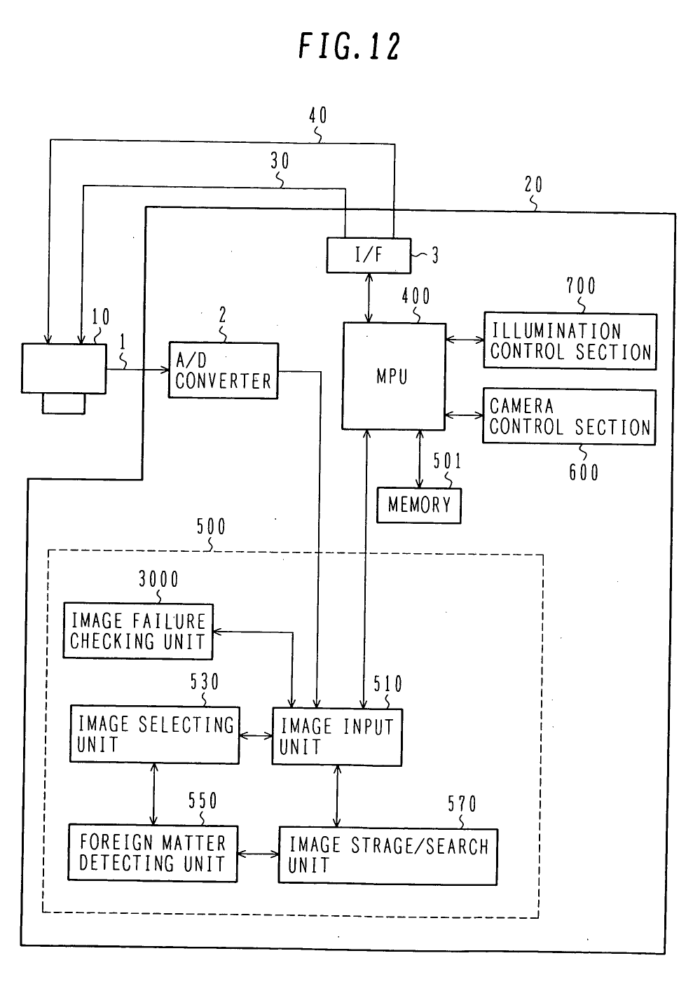

FIG. 12 is a block diagram of the image processing section 500 of the image processor 20 according to another embodiment of the present invention. This embodiment has substantially the same block diagram as that shown in FIG. 11 except that this embodiment includes an image failure checking unit 3000 for checking a failure of the taken-in video signal 1, i.e., an image failure.

When the MPU 400 issues an image taking-in command, the image input unit 510 takes in an image at each focus position under focus control by the camera control section 600, and the image failure checking unit 3000 checks average brightness, edge images, etc. to determine the presence of an image failure. When the result of checking the image failure is normal, the image selecting unit 530 selects, from among the images thus taken in at the respective focus positions, an image in focus with the liquid surface or a clearest image of the liquid surface. Then, the foreign matter detecting unit 550 checks the presence and position of mirror reflection based on the selected image, thereby detecting the foreign matter. The image storage/search unit 570 stores, in the memory 501, the image used by the foreign matter detecting unit 550 for checking the foreign matter. In response to a request from the operator 1000, the MPU 400 commands the display control section 800 to display the desired images and information stored in the memory 501, whereupon the display control section 800 displays it on the display 900. Thus, the operator 1000 is able to confirm and search for the desired images and information on the screen of the display 900.

On the other hand, when the image failure checking unit 3000 indicates an abnormal state as the result of checking average brightness, edge images, etc. and determining the presence of the image failure, the MPU 400 is informed of the fact that the image inputted to the image input unit 510 is abnormal, followed by issuing a command to stop the process under execution. As an alternative, the image detecting unit 10 may be newly operated from the start to capture an image again, or an error message may be displayed on the display 900 to inform the operator 1000 of the error situation.

Since the function of checking the image failure is able to check that an image not suitable for detection of the foreign matter is resulted due to abnormality of the image detecting unit 10 or abnormality of the video signal 1, the provision of the image failure checking unit is effective in improving reliability without reducing the detection accuracy.

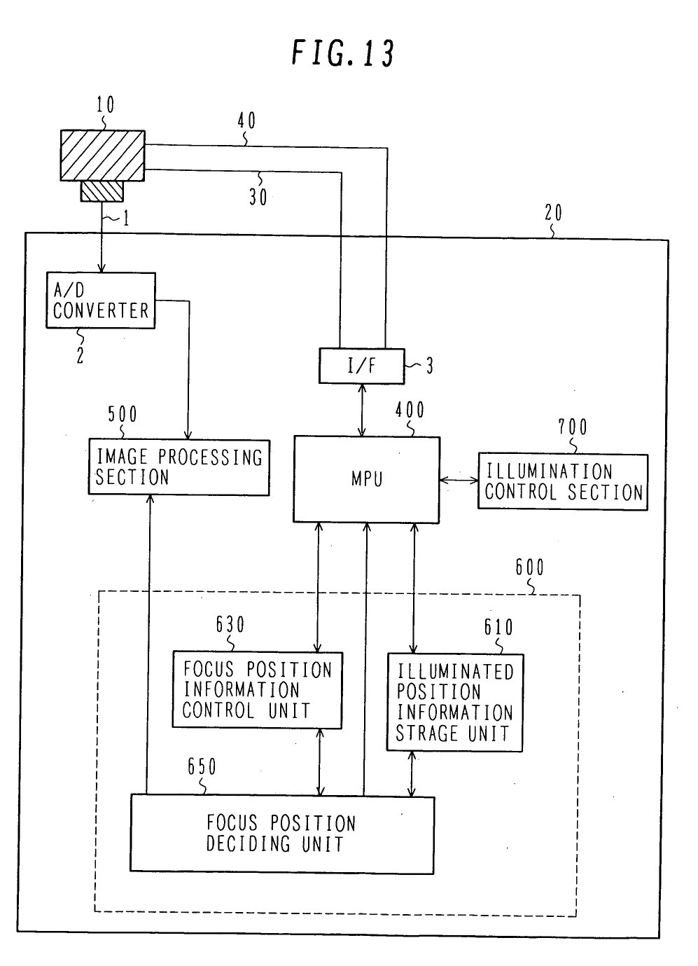

FIG. 13 is a block diagram of the camera control section 600 of the image processor 20 according to one embodiment of the present invention.

When the MPU 400 issues a control command to change the focus position of the image capturing unit 10 at least over the range from the top of the container 50, which contains the liquid whose surface is to be examined, to the bottom thereof, a focus position information control unit 630 first issues a command to make the focus matched with a position of the top of the container 50. Then, a focus position deciding unit 650 decides the focus position as the position of the top of the container 50 and informs the decided focus position to each of the image processing section 500, an illuminated position information storage unit 610, and the MPU 400. The illuminated position information storage unit 610 stores an illuminated position therein based on the focus position that has been decided by the focus position deciding unit 650. When the MPU 400 is informed of the focus position decided by the focus position deciding unit 650, it outputs a signal indicating the decided focus position as the focus control signal 30. Further, the MPU 400 takes out the illuminated position stored in the illuminated position information storage unit 610 and outputs the taken-out illuminated position to the illumination control section 700.

Subsequently, the focus position information control unit 630 issues a command to make the focus matched with a position slightly shifted downward from the top of the container 50. The focus position deciding unit 650 decides the focus position as the position slightly shifted downward from the top of the container 50 and informs the newly decided focus position to each of the image processing section 500, the illuminated position information storage unit 610, and the MPU 400. The illuminated position information storage unit 610 stores an illuminated position therein based on the focus position that has been newly decided by the focus position deciding unit 650. When the MPU 400 is informed of the focus position newly decided by the focus position deciding unit 650, it outputs a signal indicating the newly decided focus position as the focus control signal 30. Further, the MPU 400 takes out the illuminated position stored in the illuminated position information storage unit 610 and outputs the taken-out illuminated position to the illumination control section 700.

The above-described process is repeated to successively change the focus position. Finally, the focus position information control unit 630 issues a command to make the focus matched with a position of the bottom of the container 50. The focus position deciding unit 650 decides the focus position as the position of the bottom of the container 50 and informs the finally decided focus position to the image processing section 500, the illuminated position information storage unit 610, and the MPU 400. The illuminated position information storage unit 610 stores an illuminated position therein based on the focus position that has been finally decided by the focus position deciding unit 650. When the MPU 400 is informed of the focus position finally decided by the focus position deciding unit 650, it outputs a signal indicating the finally decided focus position as the focus control signal 30. Further, the MPU 400 takes out the illuminated position stored in the illuminated position information storage unit 610 and outputs the taken-out illuminated position to the illumination control section 700.

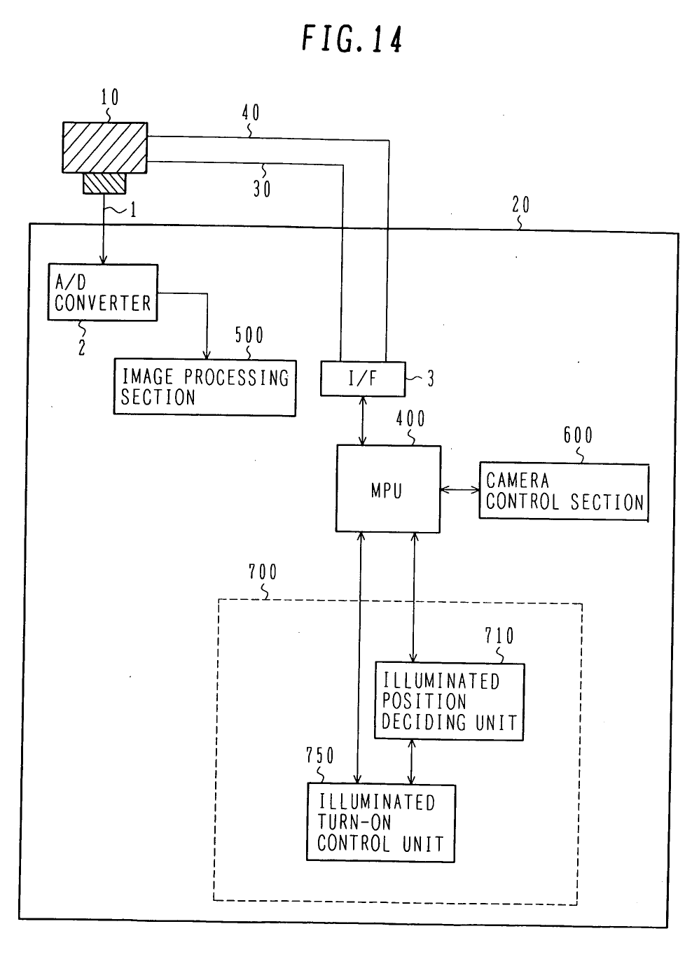

FIG. 14 is a block diagram of the illumination control section 700 of the image processor 20 according to one embodiment of the present invention. This block diagram is basically similar to those shown in FIGS. 10 to 13 except for the illumination control section 700. When the MPU 400 takes out the illuminated position stored in the illuminated position information storage unit 610 as required, an illuminated position deciding unit 710 selects the LED and decides the position where the LED is to be turned on. Then, an illumination turn-on control unit 750 outputs the illumination turn-on position decided by the illuminated position deciding unit 710 to the MPU 400, whereupon the MPU 400 outputs a signal for turning on only the selected LED and turning off the other LED's, as the illumination control signal 40, to the LED's 200, 210 and 220.

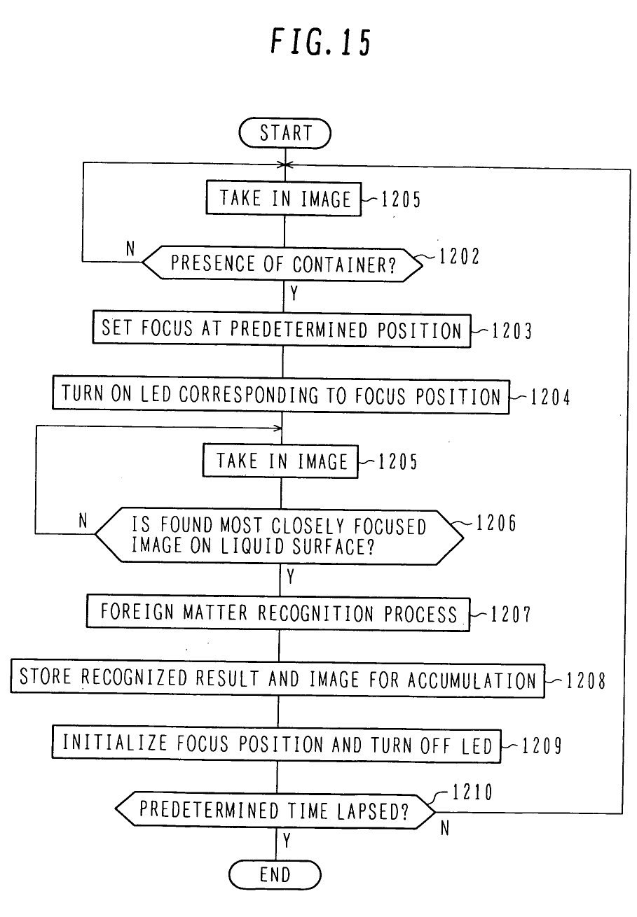

FIG. 15 is a flowchart of a detection processing procedure executed in the foreign matter detecting system according to one embodiment of the present invention, the flowchart representing the processing procedure for the system shown in FIG. 6.

First, in step 1201, the image inputted to the image input unit 510 is taken in to perform determination as to whether the container 50 is present. In step 1202, the presence or absence of the container 50 is determined. If the container 50 is absent, the control flow returns to step 1201, and if the container 50 is present, the control flow advances to step 1203. The determination on the presence of the container 50 is made depending on the shape of the container 50. For example, when the container 50 is circular, the presence of the container 50 is determined by checking the presence of a circular shape with the generalized Hough transform method. If the container 50 is present, the focus is matched with a predetermined position outputted as the outputted focus control signal 30 in step 1203, and the LED at a predetermined position outputted as the illumination control signal 40 is turned on in step 1204. Then, in step 1205, the image inputted to the image input unit 510 is taken in to perform determination as to the presence of a foreign matter.

In step 1206, it is determined whether the image acquired in step 1205 is an image most closely focused on the liquid surface (in-focus image), i.e., a clear image. If it is the in-focus image or the clear image, the control flow advances to step 1207, and if not so, the control flow returns to step 1205. The determination process in step 1206 is performed as follows. The input image desiredly acquired in step 1205 is first regarded as a candidate for the in-focus image or the clear image. Then, the current input image next acquired is compared with the previous candidate for the image area of an edge in the liquid surface or thereabout. If the current input image has a smaller edge area, it is regarded as a new candidate. Such a comparison is repeated until a new candidate is no more found. If a new candidate is no more found, the finally found candidate is determined as the in-focus image or the clear image.

In step 1207, a foreign matter recognition process is executed based on the in-focus image or the clear image found in step 1206.

The foreign matter recognition process in step 1207 is executed by determining the occurrence of mirror reflection, i.e., the presence of the foreign matter, when an image region corresponding to the liquid surface or the vicinity thereof includes a certain or more number of spots. (e.g., three or more in the case of a bubble) each having an area within a predetermined range and larger (higher) brightness than a preset threshold, and by determining no occurrence of mirror reflection, i.e., the absence of the foreign matter, when the number of spots each having an area within the predetermined range and higher brightness than the preset threshold is less than the certain number (e.g., less than three in the case of a bubble).

In step 1208, the in-focus image or the clear image used in step 1206, i.e., the image used for recognition of the foreign matter, and the information of the recognition result are stored in the memory for accumulation regardless of whether the foreign matter is present. In step 1209, the focus position is desiredized for return to the start position, and the LED is turned off. In step 1210, it is determined whether the operation of the image processor 20 has continued in excess of a predetermined time, or whether a signal for ending the operation of the image processor 20 has been received. If the lapsed time is less than the predetermined time, or if the end-of-operation signal is not yet received, the control flow returns to step 1201. Otherwise, the control flow is brought to an end.

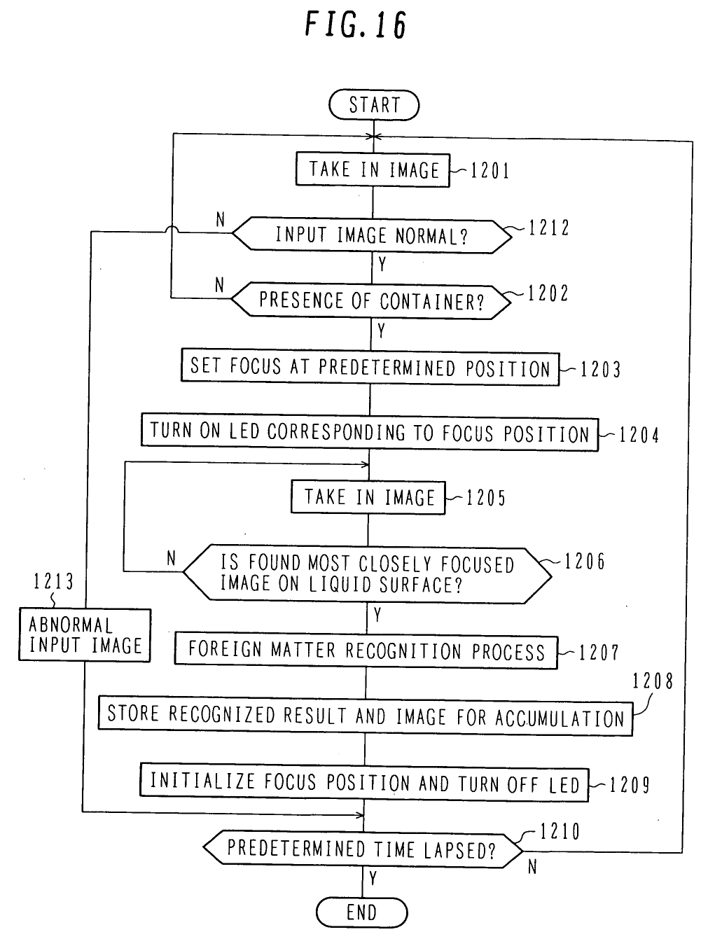

FIG. 16 is a flowchart of a detection processing procedure executed in the foreign matter detecting system according to another embodiment of the present invention, the flowchart representing the processing procedure for the image processing section 500 in FIG. 12.

In FIG. 16, steps 1201, 1202, 1203, 1204, 1205, 1206, 1207, 1208, 1209 and 1210 are the same as those in FIG. 15.

Step 1212 represents a process executed by the image failure checking unit 3000. More specifically, on the image acquired in step 1201, the image failure checking unit 3000 checks average brightness, edge images, etc. to determine whether the input image is normal. If the input image is normal, step 1202 is executed, and if not so, a message indicating an abnormality of the input image is displayed on the display 900 in step 1213. When the average brightness is extremely low and the number of edge images is extremely small, the input image is determined to be abnormal. Otherwise, the input image is determined to be normal.

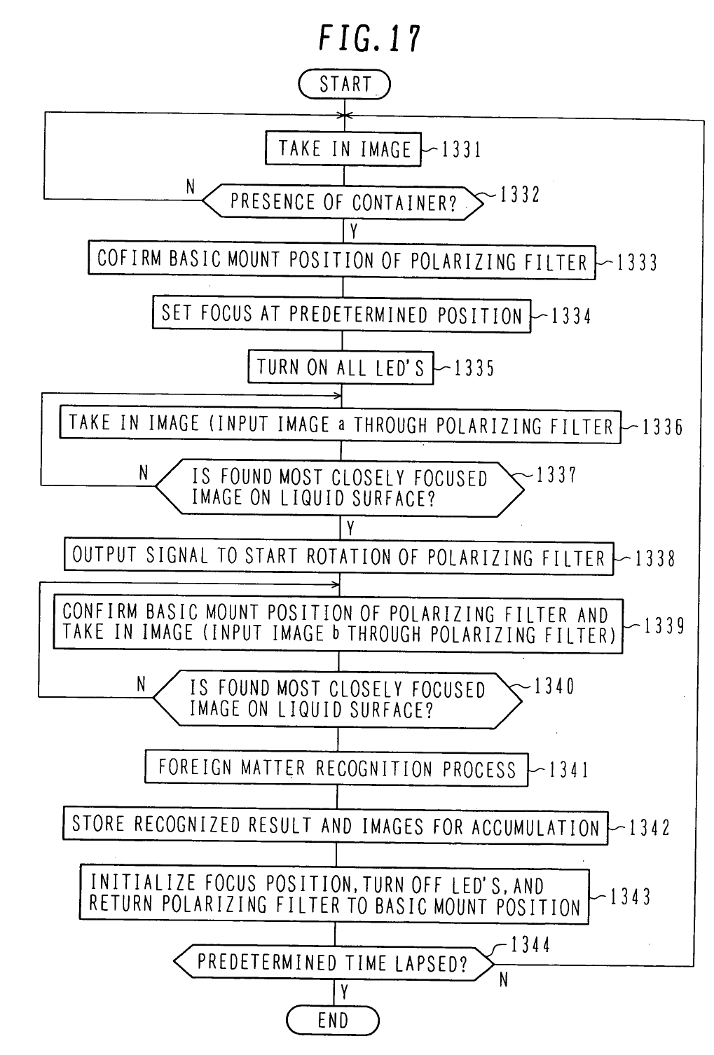

FIG. 17 is a flowchart of a detection processing procedure executed in the foreign matter detecting system according to still another embodiment of the present invention, the flowchart representing the processing procedure for the system shown in FIG. 5.

First, in step 1331, the image inputted to the image input unit 510 is taken in to perform determination as to whether the container 50 is present. In step 1332, the presence or absence of the container 50 is determined. If the container 50 is absent, the control flow returns to step 1331, and if the container 50 is present, the control flow advances to step 1333. Following the determination that the container 50 is present, it is confirmed in step 1333 that the polarizing filter is in the basic mount position. Then, the focus is matched with the predetermined position outputted as the focus control signal 30 in step 1334, and the LED's are all turned on in accordance with an all-LED turn-on signal outputted as the illumination control signal 40 in step 1335.

In step 1336, the image (i.e., the input image a through the polarizing filter) inputted to the image input unit 510 is taken in to perform determination as to the presence of a foreign matter.

In step 1337, it is determined whether the image acquired in step 1336 is an image most closely focused on the liquid surface (in-focus image), i.e., a clear image. If it is the in-focus image or the clear image, the control flow advances to step 1338, and if not so, the control flow returns to step 1336.

When a signal for starting the rotation of the polarizing filter is outputted to the polarizing filter rotating device 320 in step 1338, the polarizing filter is rotated and stopped at a predetermined position (e.g., a position after the polarizing filter has rotated 90°). In step 1339, after confirming that the polarizing filter is in the control mount position, the image (i.e., the input image b through the polarizing filter) is taken in to perform determination as to the presence of a foreign matter.

In step 1340, it is determined whether the image acquired in step 1339 is an image most closely focused on the liquid surface (in-focus image), i.e., a clear image. If it is the in-focus image or the clear image, the control flow advances to step 1341, and if not so, the control flow returns to step 1339. The determination in each of steps 1337, 1340 can be performed in the same manner as that in step 1206.

The subsequent processing is executed through steps 1341, 1342, 1343 and 1344.

Processes executed in steps 1342 and 1344 are respectively the same as those executed in steps 1208 and 1210.

The foreign matter recognition process in step 1341 is executed as follows. A common zone within an image region corresponding to the liquid surface or the vicinity thereof, in which spots each having an area within a predetermined range and high brightness are present at the same positions, is extracted from each of the image most closely focused on the liquid surface or the clear image among the input images a through the polarizing filter and the image most closely focused on the liquid surface or the clear image among the input images b through the polarizing filter. Then, the occurrence of mirror reflection, i.e., the presence of the foreign matter, is determined when the extracted zone includes a certain or more number of spots (e.g., three or more in the case of a bubble) each having an area within the predetermined range and high brightness. On the other hand, no occurrence of mirror reflection, i.e., the absence of the foreign matter, is determined when the number of spots each having an area within the predetermined range and high brightness is less than the certain number (e.g., less than three in the case of a bubble).

In step 1343, the focus position of the image capturing unit 10 is returned to the desired position, and the LED's are turned off, and the polarizing filter is returned to the basic mount position.

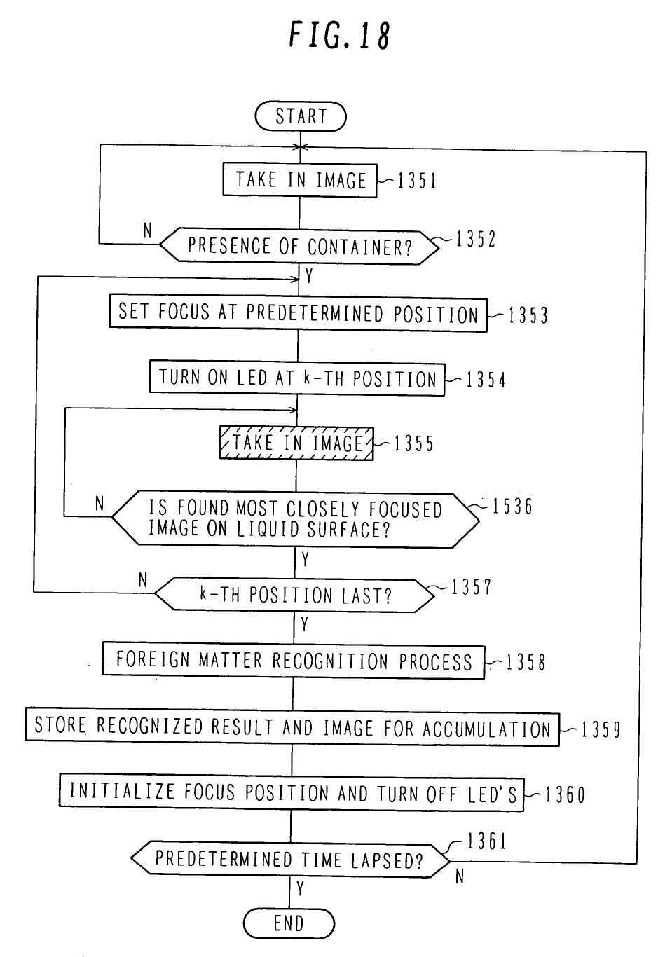

FIG. 18 is a flowchart of a detection processing procedure executed in the foreign matter detecting system according to still another embodiment of the present invention, the flowchart representing the processing procedure for the system shown in FIG. 6.

First, in step 1351, the image inputted to the image input unit 510 is taken in to perform determination as to whether the container 50 is present. In step 1352, the presence or absence of the container 50 is determined. If the container 50 is absent, the control flow returns to step 1351, and if the container 50 is present, the control flow advances to step 1353. Following the determination that the container 50 is present, the focus is matched with the predetermined position outputted as the focus control signal 30 in step 1353, and only the LED 340 at the k-th position outputted as the illumination control signal 40 is turned on in step 1354.

In step 1355, the image (i.e., the input image in the illumination direction A) inputted to the image input unit 510 is taken in to perform determination as to the presence of a foreign matter.

In step 1356, it is determined whether the image acquired in step 1355 is an image most closely focused on the liquid surface (in-focus image), i.e., a clear image. If it is the in-focus image or the clear image, the control flow advances to step 1357, and if not so, the control flow returns to step 1355. In step 1357, it is checked whether the LED 360 at the k-th position is the last one. If the k-th position is the last one, the control flow advances to step 1358, and if not so, the control flow returns to step 1354.

In step 1358, a foreign matter recognition process is executed based on the images most closely focused on the liquid surface or the clear images selected respectively from among the input images in the illumination direction A, the input images in the illumination direction B, and the input images in the illumination direction C.

More specifically, the foreign matter recognition process in step 1358 is executed as follows. As shown in FIG. 7 to 9, because the ray of light 345 from the LED 340 corresponding to the illumination direction A is illuminated from an upper left position, the mirror reflection 346 occurs in an upper left area of the projected surface of the foreign matter 300. Because the ray of light 355 from the LED 350 corresponding to the illumination direction B is illuminated from a just above position, the mirror reflection 356 occurs in an upper central area of the projected surface of the foreign matter 300. Further, because the ray of light 365 from the LED 360 corresponding to the illumination direction C is illuminated from an upper right position, the mirror reflection 366 occurs in an upper right area of the projected surface of the foreign matter 300. When the mirror reflection 346 caused with the illumination from the LED 340 corresponding to the illumination direction A, the mirror reflection 356 caused with the illumination from the LED 350 corresponding to the illumination direction B, and the mirror reflection 366 caused with the illumination from the LED 360 corresponding to the illumination direction C occur in different positions from one another, it is determined that the foreign matter is a three-dimensional object. Otherwise, there is no three-dimensional foreign matter.

Processes executed in steps 1359, 1360 and 1361 are respectively the same as those executed in steps 1208, 1209 and 1210.

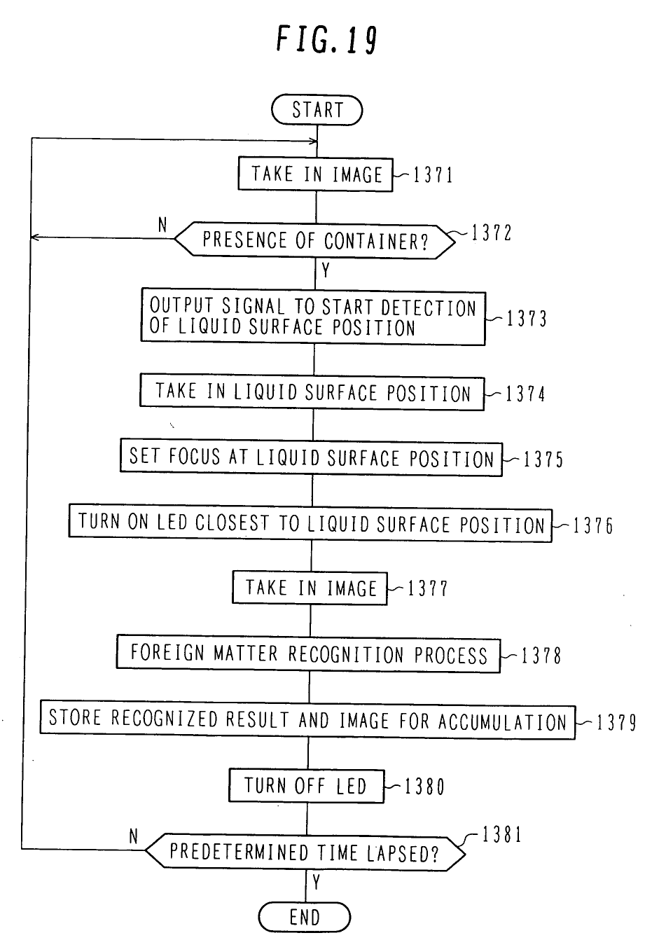

FIG. 19 is a flowchart of a detection processing procedure executed in the foreign matter detecting system according to still another embodiment of the present invention, the flowchart representing the processing procedure for the system shown in FIG. 10.

First, in step 1371, the image inputted to the image input unit 510 is taken in to perform determination as to whether the container 50 is present. In step 1372, the presence or absence of the container 50 is determined. If the container 50 is absent, the control flow returns to step 1371, and if the container 50 is present, the control flow advances to step 1373. Following the determination that the container 50 is present, a signal for starting the detection of the liquid surface is sent to the liquid surface position sensor 1100 in step 1373. When the liquid surface position detected by the liquid surface position sensor 1100 is received, the received liquid surface position is acquired in step 1374. The liquid surface position sensor 1100 may be constructed of a known ordinary device, e.g., a liquid surface position sensor using an ultrasonic wave.

In step 1375, the focus control signal 30 is outputted as a signal to make the focus matched with the liquid surface position acquired in step 1374, and the illumination control signal 40 is outputted in step 1376 to turn on the LED at the liquid surface position acquired in step 1374. Then, in step 1377, the image inputted to the image input unit 510 is taken in to perform determination as to the presence of a foreign matter. In step 1378, a foreign matter recognition process is executed based on the image acquired in step 1377.

Processes executed in steps 1378 and 1379 are respectively the same as those executed in steps 1207 and 1208. In step 1380, the LED is turned off. Then, it is determined in step 1381 whether the operation of the image processor 20 has continued in excess of a predetermined time, or whether a signal for ending the operation of the image processor 20 has been received. If the lapsed time is less than the predetermined time, or if the end-of-operation signal is not yet received, the control flow returns to step 1371. Otherwise, the control flow is brought to an end.

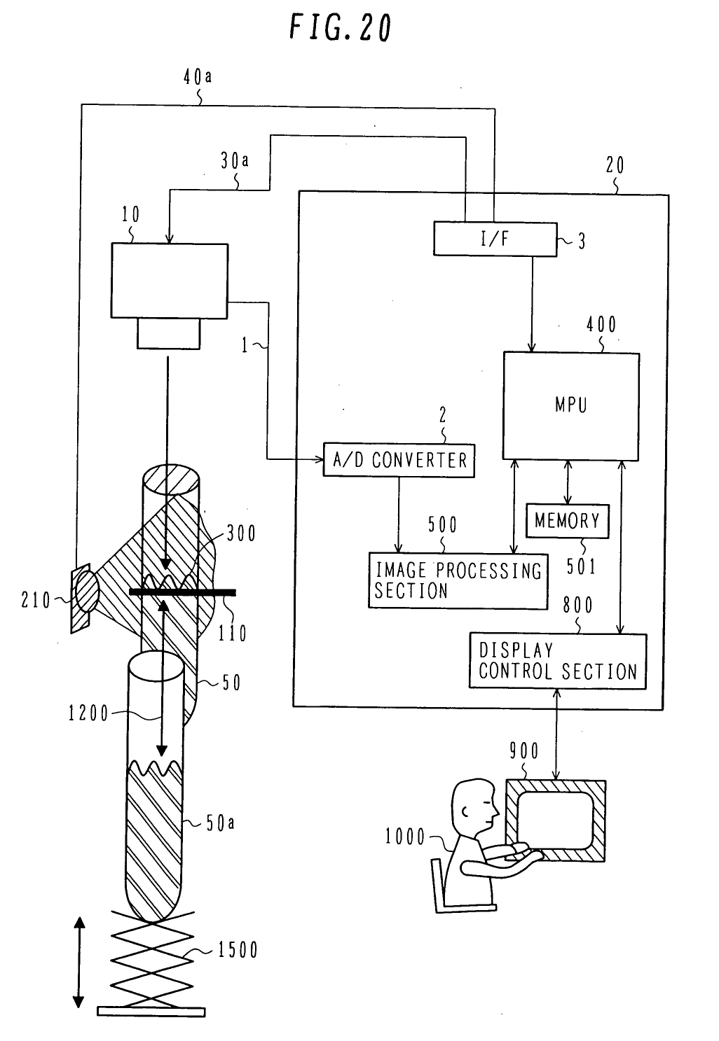

FIG. 20 is an explanatory view of a foreign matter detecting system according to still another embodiment of the present invention.

In the foreign matter detecting system of this embodiment, the image capturing unit 10 is disposed above the container 50 to face the liquid surface, and the focus position of the image capturing unit 10 is fixed in an arbitrary position (e.g., the focus position 110). Only one LED 210 is fixedly positioned corresponding to the fixed focus position 110 and is turned on to illuminate the liquid surface laterally of the container 50.

A command 30a for making the focus position of the image capturing unit 10 matched with the fixed focus position 110 is not always required, and the image capturing unit 10 can be manually adjusted to be focused on the fixed position. A command 40a for turning on only the LED 210 is also not ways required, and the LED 210 can be manually fixed in a position corresponding to the fixed focus position 110 and turned on to illuminate the liquid surface.

Then, a container moving device 1500 is controlled such that the top of the container 50 is vertically moved toward and away from a lens of the image capturing unit 10. When the container 50 is vertically moved from a position shown at 50a to a position shown at 50 as indicated by an arrow 1200, the liquid surface is matched with the focus position 110 and is illuminated by the turned-on LED 210. Accordingly, if the foreign matter 300 is present on the liquid surface, a most closely focused or clear image of the foreign matter 300 and mirror reflection caused by the foreign matter 300 can be observed. If the foreign matter 300 is absent, there occurs no mirror reflection. The container moving device 1500 may be constructed of a known ordinary device.

The image received by the image capturing unit 10 at the focus position 110 is taken into the image processing section 500 of the image processor 20. The image processing section 500 checks the presence and position of the mirror reflection based on the input image thus taken in, thereby detecting the foreign matter. The image used for checking the foreign matter is stored in the memory. In response to a request from the operator 1000, the MPU 400 commands the display control section 800 to display the desired images and information stored in the memory, whereupon the display control section 800 displays it on the display 900. Thus, the operator 1000 is able to confirm and search for the desired images and information on the screen of the display 900.

As described above, since the container is moved toward and away from the lens of the image capturing unit, the liquid under examination can be detected as including a foreign matter and can be excluded from the examination subject regardless of the magnitude of a level difference of the liquid surface to be examined if there is a bubble, an air bubble, dust or the like in the container and/or the liquid surface, or if there is a projection on the liquid surface. Therefore, the detection accuracy of precision instruments, etc. can be prevented from deteriorating due to the presence of an obstacle, such as a foreign matter, and reliability can be improved. In addition, since the focus position is kept fixed, this embodiment can be realized with the use of a relatively inexpensive camera.

Further, since the images used for checking the foreign matter are stored in the memory, the desired images and information can be displayed on the display through the display control section, and the operator can display and search the stored images and information as required. It is hence possible to present, as a proof, the image that has been used for determining the detection result.

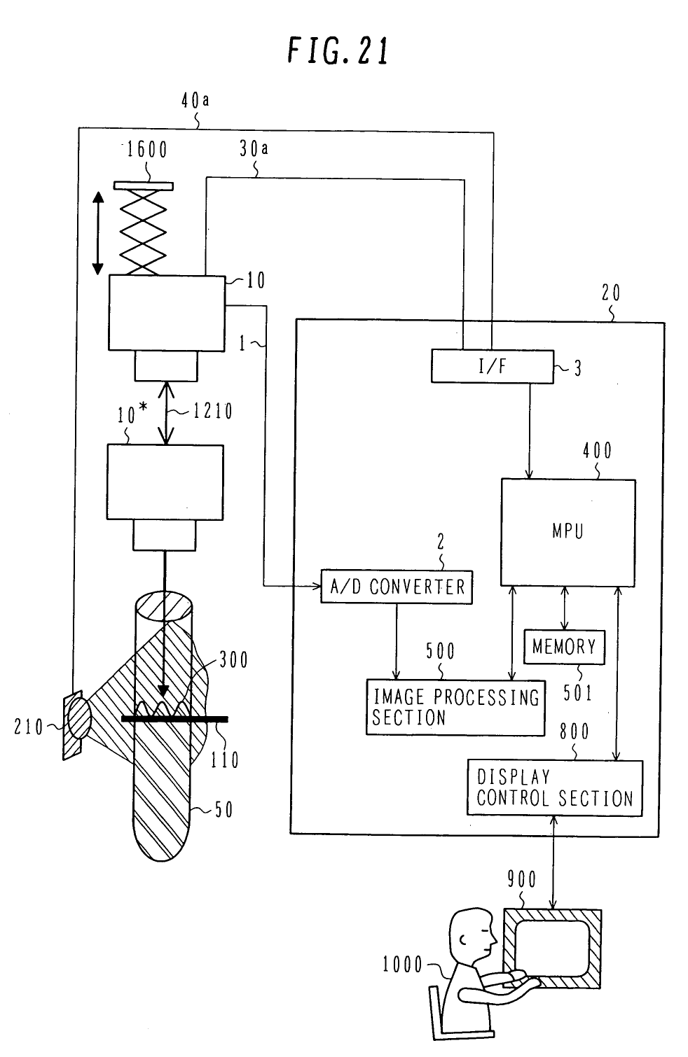

FIG. 21 is an explanatory view of a foreign matter detecting system according to still another embodiment of the present invention.

In the foreign matter detecting system of this embodiment, unlike the system of FIG. 20, the container 50 is held fixed and a camera moving device is provided to move the image capturing unit 10.

First, the LED 210 is disposed in a fixed position just laterally of the liquid surface and is turned on to illuminate the liquid surface in the container 50 sideways. The image capturing unit 10 is disposed above the container 50 to face the liquid surface, and the focus position of the image capturing unit 10 is fixed in one arbitrary position. A command 30a for making the focus position of the image capturing unit 10 matched with the arbitrary fixed position is not always required, and the image capturing unit 10 can be manually adjusted to be focused on the arbitrary fixed position. A command 40a for turning on only the LED 210 is also not always required, and the LED 210 can be manually fixed in a position corresponding to the liquid surface and turned on to illuminate the liquid surface just sideways.

Then, a camera moving device 1600 is controlled such that the image capturing unit 10 is vertically moved toward and away from the top of the container 50. When the image capturing unit 10 is vertically moved from a position shown at 10 to a position shown at 10* as indicated by an arrow 1210, the focus position 110 is matched with the liquid surface that is illuminated by the turned-on LED 210 just sideways. Accordingly, if the foreign matter 300 is present on the liquid surface, a most closely focused or clear image of the foreign matter 300 and mirror reflection caused by the foreign matter 300 can be observed. If the foreign matter 300 is absent, there occurs no mirror reflection. The camera moving device 1600 may be constructed of a known ordinary device.

The image received by the image capturing unit 10 at the focus position 110 is taken into the image processing section 500 of the image processor 20. The image processing section 500 checks the presence and position of the mirror reflection based on the input image thus taken in, thereby detecting the foreign matter. The image used for checking the foreign matter is stored in the memory. In response to a request from the operator 1000, the MPU 400 commands the display control section 800 to display the desired images and information stored in the memory, whereupon the display control section 800 displays it on the display 900. Thus, the operator 1000 is able to confirm and search for the desired images and information on the screen of the display 900.

As described above, since the image capturing unit is moved toward and away from the top of the container, the liquid under examination can be detected as including a foreign matter and can be excluded from the examination subject regardless of the magnitude of a level difference of the liquid surface to be examined if there is a bubble, an air bubble, dust or the like in the container and/or the liquid surface, or if there is a projection on the liquid surface. Therefore, the detection accuracy of precision instruments, etc. can be prevented from deteriorating due to the presence of an obstacle, such as a foreign matter, and reliability can be improved. In addition, since the focus position is kept fixed, this embodiment can be realized with the use of a relatively inexpensive camera.

Further, since the images used for checking the foreign matter are stored in the memory, the desired images and information can be displayed on the display through the display control section, and the operator can display and search the stored images and information as required. It is hence possible to present, as a proof, the image that has been used for determining the detection result.

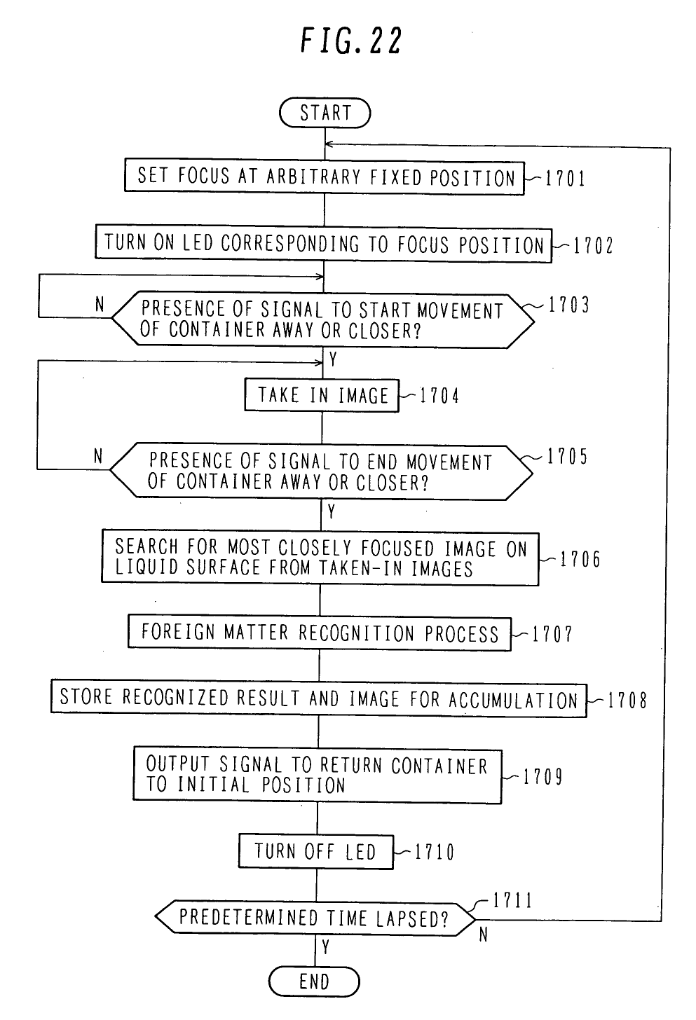

FIG. 22 is a flowchart of a detection processing procedure executed in the foreign matter detecting system according to still another embodiment of the present invention, the flowchart representing the processing procedure for the system shown in FIG. 20.

In step 1701, the focus position of the image capturing unit 10 is matched with the arbitrary fixed position outputted as the focus command 30a. In step 1702, the LED corresponding to the arbitrary fixed position with which the focus has been matched in step 1701.

In step 1703, a container movement signal is sent to the container moving device 1500 to check whether a signal for starting the movement of the container moving device 1500 away from or closer to the image capturing unit 10 has been received, followed by waiting for reception of the start-of-movement signal. If the start-of-movement signal is received, the image inputted to the image input unit 510 is acquired in step 1704 to perform determination as to the presence of a foreign matter. In step 1705, it is checked whether a signal for ending the movement of the container moving device 1500 away or closer has been received. Step 1704 is repeated until the end-of-movement signal is received.

In step 1706, it is determined whether the image acquired in step 1704 is an image most closely focused on the liquid surface (in-focus image), i.e., a clear image. After searching for the in-focus image or the clear image is found, the control flow advances to step 1707.

The determination process in step 1706 is performed as follows. The input image desiredly acquired in step 1704 is first regarded as a candidate for the in-focus image or the clear image. Then, the current input image next acquired is compared with the previous candidate for the image area of an edge in the liquid surface or thereabout. If the current input image has a smaller edge area, it is regarded as a new candidate. Such a comparison is repeated until a new candidate is no more found. If a new candidate is no more found, the finally found candidate is determined as the in-focus image or the clear image.

In step 1707, a foreign matter recognition process is executed based on the in-focus image or the clear image found in step 1706. The process of step 1707 is executed in the same manner as in step 1207.

In step 1708, the in-focus image or the clear image used in step 1707, i.e., the image used for recognition of the foreign matter, and the information of the recognition result are stored in the memory for accumulation regardless of whether the foreign matter is present.

In step 1709, a signal for returning the container 50 to the desired position is sent to the container moving device 1500. Then, the LED is turned off in step 1710. In step 1711, it is determined whether the operation of the image processor 20 has continued in excess of a predetermined time, or whether a signal for ending the operation of the image processor 20 has been received. If the lapsed time is less than the predetermined time, or if the end-of-operation signal is not yet received, the control flow returns to step 1701. Otherwise, the control flow is brought to an end.

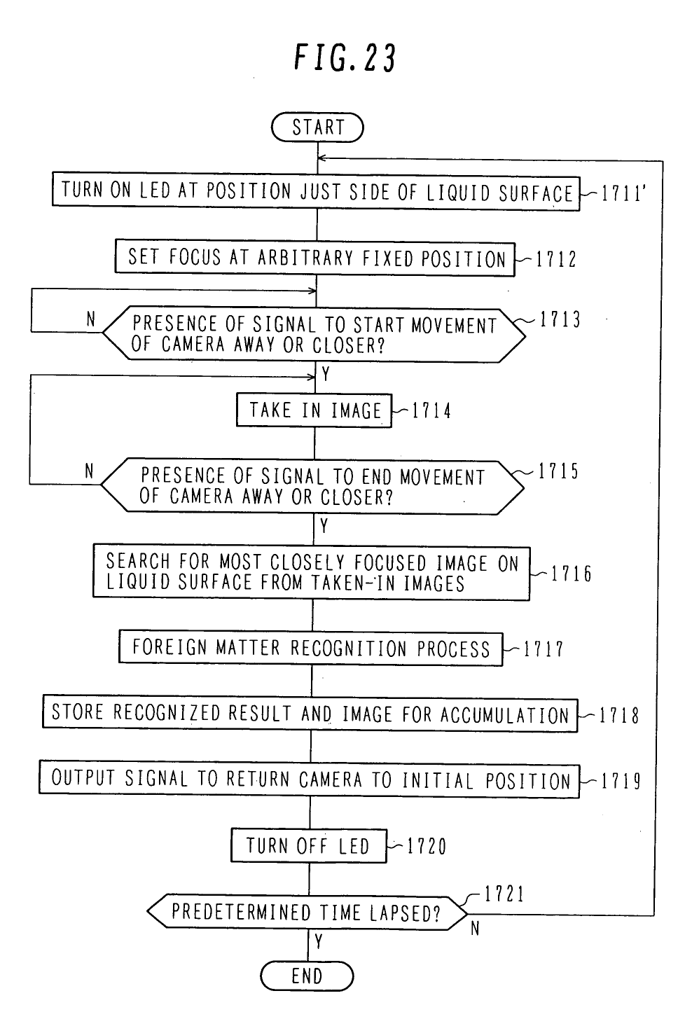

FIG. 23 is a flowchart of a detection processing procedure executed in the foreign matter detecting system according to still another embodiment of the present invention, the flowchart representing the processing procedure for the system shown in FIG. 21.

In step 1711′, the LED disposed at the fixed position is turned on to illuminate the liquid surface just sideways. In step 1712, the focus position of the image capturing unit 10 disposed above the container 50 to face the liquid surface is fixedly set to an arbitrary position.

In step 1713, a camera movement signal is sent to the camera moving device 1600 to check whether a signal for starting the movement of the camera moving device 1600 away from or closer to the container 50 has been received, followed by waiting for reception of the start-of-movement signal. If the start-of-movement signal is received, the image inputted to the image input unit 510 is acquired in step 1714 to perform determination as to the presence of a foreign matter. In step 1715, it is checked whether a signal for ending the movement of the camera moving device 1600 away or closer has been received. Step 1714 is repeated until the end-of-movement signal is received.

In step 1716, it is determined whether the image acquired in step 1714 is an image most closely focused on the liquid surface (in-focus image), i.e., a clear image. After searching for the in-focus image or the clear image, the control flow advances to step 1717.

The determination process in step 1716 is the same as that in step 1706. In step 1717, a foreign matter recognition process is executed based on the in-focus image or the clear image found in step 1716. The process of step 1717 is executed in the same manner as in step 1707.

In step 1718, the in-focus image or the clear image used in step 1717, i.e., the image used for recognition of the foreign matter, and the information of the recognition result are stored in the memory for accumulation regardless of whether the foreign matter is present.

In step 1719, a signal for returning the camera of the image capturing unit 10 to the desired position is sent to the camera moving device 1600. Then, the LED is turned off in step 1720. In step 1721, it is determined whether the operation of the image processor 20 has continued in excess of a predetermined time, or whether a signal for ending the operation of the image processor 20 has been received. If the lapsed time is less than the predetermined time, or if the end-of-operation signal is not yet received, the control flow returns to step 1711′. Otherwise, the control flow is brought to an end.

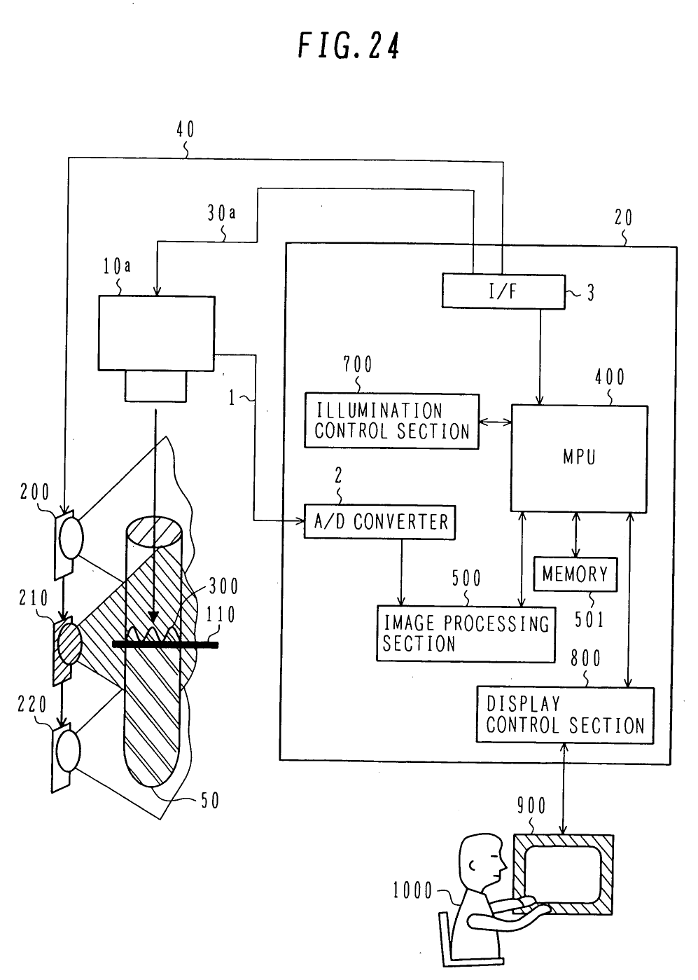

FIG. 24 is an explanatory view of a foreign matter detecting system according to still another embodiment of the present invention.

The foreign matter detecting system of this embodiment basically has the same configuration as the system of FIG. 1 except that the image capturing unit is designed in an automatically controllable manner.

An image capturing unit 10a having a focus position automatically controllable by a camera itself is disposed above the container 50 to face the liquid surface, and only the LED 200 disposed laterally of the top position of the container 50 is turned on to illuminate the liquid surface sideways. Then, only the LED 210 disposed laterally of the intermediate position of the container 50 is turned on to illuminate the liquid surface sideways. Finally, only the LED 220 disposed laterally of the bottom position of the container 50 is turned on to illuminate the liquid surface sideways.

With that arrangement, the automatically controllable focus of the image capturing unit 10a is easily matched with the illuminated position. Assuming, for example, that the liquid surface is present at the intermediate position, indicated by 110, of the container 50, because the LED 210 is turned on for illumination, the focus position is set near the intermediate position 110 of the container 50 and the liquid surface is captured as a clear image.

Also, since the focus position of the image capturing unit 10a is automatically controlled by the camera itself, the command 30a for making the focus position matched with the desired focus position, e.g., the position 110. Commands for turning on only one of the LED 200, LED 210 and LED 220 in turn for sequential illumination can be obtained by the MPU 400 of the image processor 20, which issues a control command to the illumination control section 700 to output the illumination control signal 40 as a parallel signal.

The image received by the image capturing unit 10a is taken into the image processing section 500 of the image processor 20. The image processing section 500 checks the presence and position of the mirror reflection based on the input image thus taken in, thereby detecting the foreign matter. If the foreign matter 300 is present on the liquid surface, mirror reflection is caused by the foreign matter 300. If the foreign matter 300 is absent, there occurs no mirror reflection. The image used for checking the foreign matter is stored in the memory, and the display control section 800 displays the desired images and information on the display 900. Thus, the operator 1000 is able to display and search for the desired data from among the stored image and information.

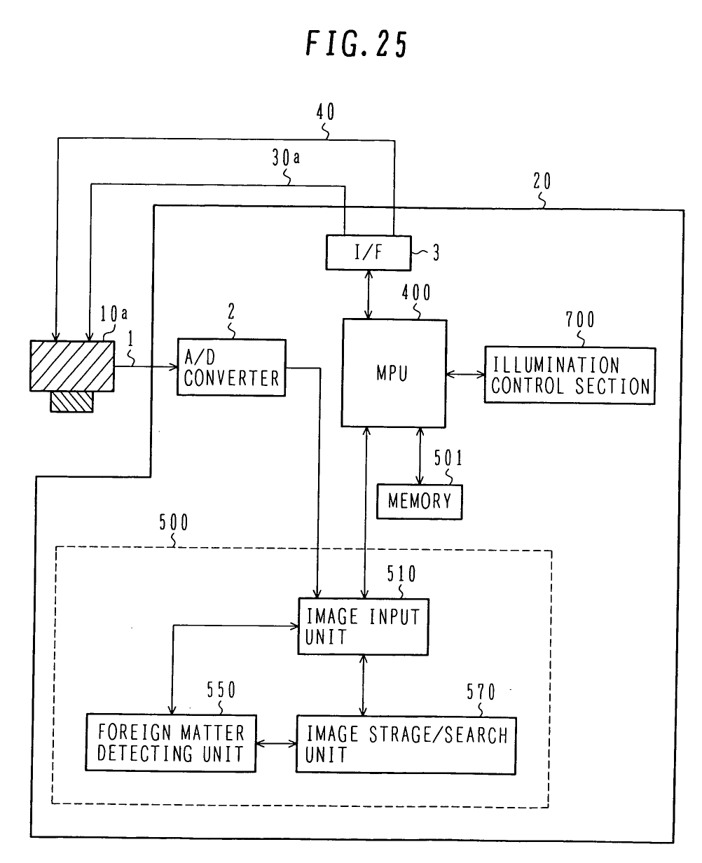

FIG. 25 is a block diagram of the image processing section 500 of the image processor 20, shown in FIG. 24, according to still another embodiment of the present invention.

When the MPU 400 issues an image taking-in command, the image input unit 510 takes in an image at the position automatically focused by the image capturing unit 10a itself. The foreign matter detecting unit 550 checks the presence and position of mirror reflection based on the taken-in image, thereby detecting the foreign matter. The image storage/search unit 570 stores, in the memory, the image used by the foreign matter detecting unit 550 for checking the foreign matter. In response to a request from the operator 1000, the MPU 400 commands the display control section 800 to display the desired images and information stored in the memory, whereupon the display control section 800 displays it on the display 900. Thus, the operator 1000 is able to confirm and search for the desired images and information on the screen of the display 900.

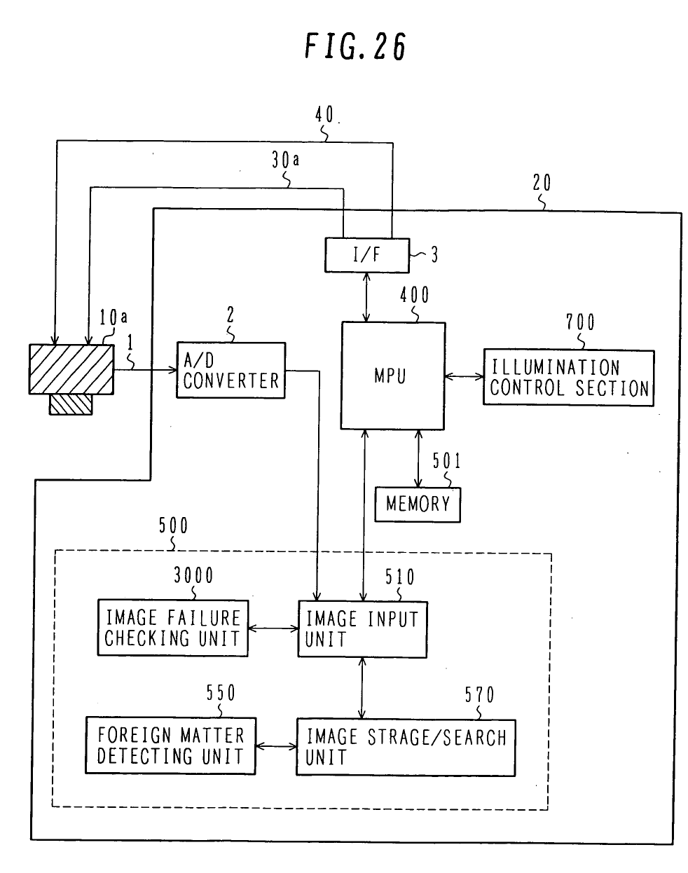

FIG. 26 is a block diagram of the image processing section 500 of the image processor 20 according to still another embodiment of the present invention. This embodiment includes the image failure checking unit 3000 additionally disposed in the image processing section 500.

When the MPU 400 issues an image taking-in command, the image input unit 510 takes an image at the position automatically focused by the image capturing unit 10a itself. The image failure checking unit 3000 checks average brightness, edge images, etc. to determine the presence of an image failure. When the result of checking the image failure is normal, the foreign matter detecting unit 550 checks the presence and position of mirror reflection based on the taken-in image, thereby detecting the foreign matter. The image storage/search unit 570 stores, in the memory, the image used by the foreign matter detecting unit 550 for checking the foreign matter. In response to a request from the operator 1000, the MPU 400 commands the display control section 800 to display the desired images and information stored in the memory, whereupon the display control section 800 displays it on the display 900. Thus, the operator 1000 is able to confirm and search for the desired images and information on the screen of the display 900.

On the other hand, if any abnormality is found as the result of checking average brightness, edge images, etc. by the image failure checking unit 3000 and determining the presence of an image failure, the MPU 400 is informed of that the image inputted to the image input unit 510 is abnormal. Then, the MPU 400 issues a command to, for example, stop the processing.

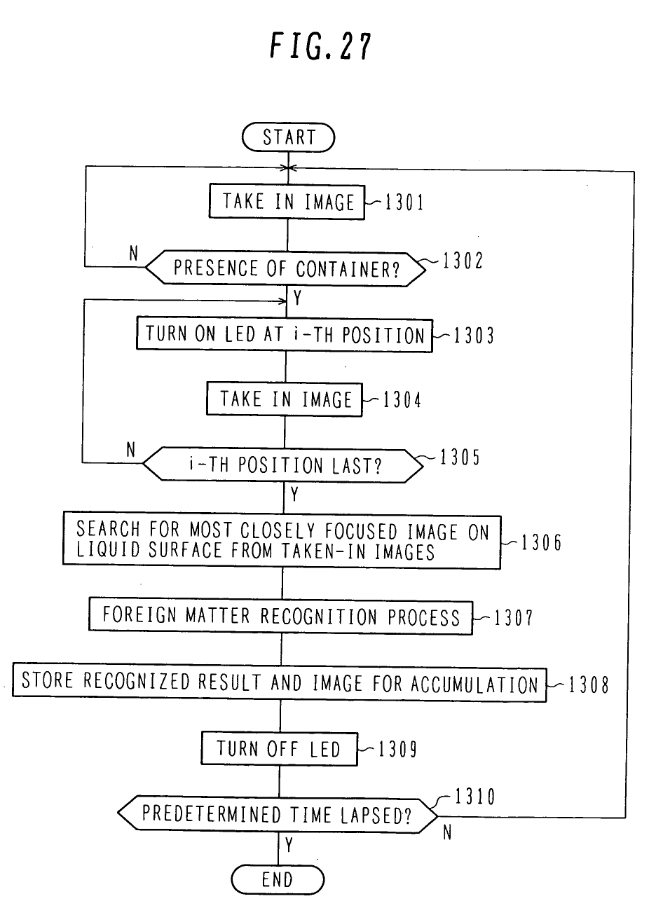

FIG. 27 is a flowchart of a detection processing procedure executed in the foreign matter detecting system according to still another embodiment of the present invention, the flowchart representing the processing procedure executed by the image processing section 500 in FIG. 25.

First, in step 1301, the image outputted from the image capturing unit boa is inputted to the image input unit 510 and taken in to perform determination as to whether the container 50 is present. In step 1302, the presence or absence of the container 50 is determined. If the container 50 is absent, the control flow returns to step 1301, and if the container 50 is present, the control flow advances to step 1303. Following the determination that the container 50 is present, only the LED 200 at the i-th position outputted as the illumination control signal 40 is turned on in step 1303.

In step 1304, the image inputted to the image input unit 510 is also taken in to perform determination as to the presence of a foreign matter. In step 1305, it is checked whether the LED 220 at the i-th position is the last one. If the i-th position is the last one, the control flow advances to step 1306, and if not so, the control flow returns to step 1303. A process of step 1306 searches for an image most closely focused on the liquid surface or a clear image from among the images acquired in step 1304. Thereafter, a foreign matter recognition process is executed in step 1307.

Processes executed in steps 1307 and 1308 are respectively the same as those executed in steps 1207 and 1208. Then, the LED is turned off in step 1309. In step 1310, it is determined whether the operation of the image processor 20 has continued in excess of a predetermined time, or whether a signal for ending the operation of the image processor 20 has been received. If the lapsed time is less than the predetermined time, or if the end-of-operation signal is not yet received, the control flow returns to step 1301. Otherwise, the control flow is brought to an end.

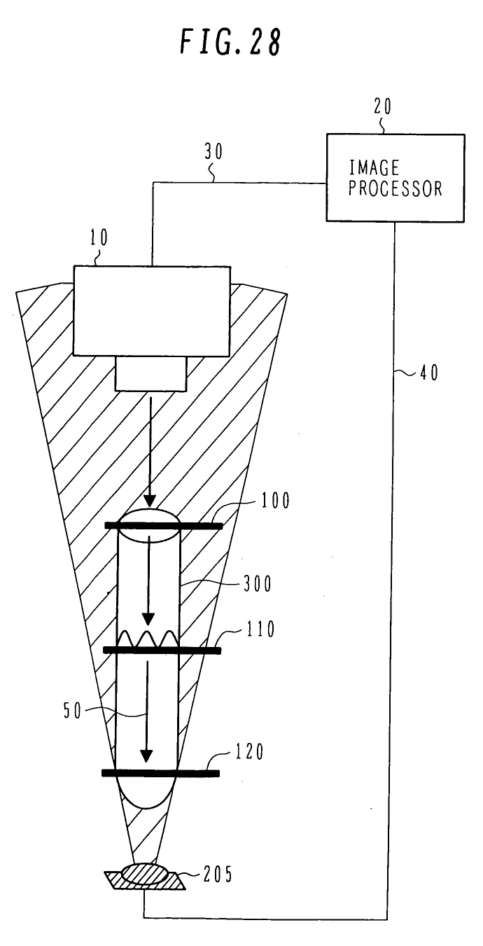

FIG. 28 is an explanatory view of a foreign matter detecting system according to still another embodiment of the present invention.

In the foreign matter detecting system of this embodiment, a light source is disposed below the container unlike the embodiments described above.

The image capturing unit 10 having an externally controllable focus position is disposed above the container 50 to face the liquid surface, and an LED 205 disposed below the container 50 is turned on to illuminate the liquid surface from below. By successively changing the focus position of the image capturing unit 10 as indicated by 100, 110 and 120, a clear image of the liquid surface is obtained when the liquid surface is matched with the focus position 110. Then, if the foreign matter 300 is present on the liquid surface, the foreign matter 300 is captured as a low-brightness image, i.e., a black image.

A command for successively changing the focus position of the image capturing unit 10 in such a manner is realized by the MPU 400 of the image processor 20, which issues a control command to the camera control section 600 so as to output the focus control signal 30 via an RS-232C line.

Also, a command for turning on the LED 205 to illuminate the liquid surface from below the container 50 is realized by the MPU 400 of the image processor 20, which issues a control command to the illumination control section 700 so as to output the illumination control signal 40 via as a parallel signal.

At each of the focus positions 100, 110 and 120 successively changed over a certain range, an image is received by the image capturing unit 10 and taken into the image processing section 500 of the image processor 20. The image processing section 500 selects an image focused on the liquid surface or a clearest image of the liquid surface from among the input images thus taken in, and checks the presence and position of a low-brightness area, i.e., a black area, in the liquid surface based on the selected image, thereby detecting the foreign matter. The image used for checking the foreign matter is stored in the memory, and the display control section 800 displays the desired images and information on the display 900. Thus, the operator 1000 is able to display and search for the desired data of the stored images and information as required.

With the above-described backlight illumination method in which the image capturing unit is disposed above the liquid surface and the LED is turned on to illuminate the liquid surface from below the container 50, a transparent object can be suitably imaged. A the foreign matter in the liquid or on the liquid surface is captured as a black image, and reflected light (i.e., reflection of the light source) is suppressed. If a dark object is present in a liquid area image, that object can be detected as being a foreign matter without being affected by the reflected light (i.e., the reflection of the light source).

Hence, this embodiment is advantageous in that the reflected light is ignorable, the processing procedures in the foreign matter detecting unit 550 and the constructions of the illumination unit, etc. can be remarkably simplified, and the foreign matter detecting system can be realized at a relatively low cost.

1. A foreign matter detecting system comprising:
a container capable of containing a liquid;
image capturing means disposed above said container and capable of capturing an image while changing a focus position;
a light source for emitting a ray of light to illuminate the focus position of said image capturing means; and
image processing means for executing image capturing control of said image capturing means and illumination control of said light source,
wherein said image capturing means captures an image while changing the focus position with respect to the liquid in said container, and
said image processing means takes in, from said image capturing means, image data of a liquid surface at the focus position of said image capturing means under illumination by said light source, and detects the presence of a foreign matter in the liquid based on the taken-in image data.

2. A foreign matter detecting system according to claim 1, wherein said light source is disposed laterally of said container.

3. A foreign matter detecting system according to claim 2, wherein said light source is disposed in plural over a range from the top to bottom of said container therealong.

4. A foreign matter detecting system according to claim 2, wherein said light source comprises plural groups each including a plurality of light sources disposed over a range from the top to bottom of said container therealong, and the light source groups are disposed to illuminate said container from different positions.

5. A foreign matter detecting system according to claim 2, wherein said image capturing means includes a polarizing filter disposed in front of said image capturing means and a polarizing filter rotating unit for rotating said polarizing filter.

6. A foreign matter detecting system according to claim 2, further comprising, other than said image capturing means, means for detecting a position of the liquid surface in said container.

7. A foreign matter detecting system according to claim 1, wherein said light source is disposed above said container.

8. A foreign matter detecting system according to claim 7, wherein said light source is disposed in plural, and the plurality of light sources are disposed at different positions from one another and illuminate the liquid surface in said container from the respective different positions.

9. A foreign matter detecting system according to claim 8, wherein said image processing means determines based on the taken-in image data whether the foreign matter in said container is a three-dimensional object or not.

10. A foreign matter detecting system according to claim 1, wherein said image processing means has a terminal for outputting a focus control signal to said image capturing means, a terminal for outputting an illumination control signal to said light source, and a terminal for taking in the image data from said image capturing means.

11. A foreign matter detecting system according to claim 2, further comprising a container moving unit capable of moving said container,
wherein said image capturing means acquires the image data on condition that said container is moved by said container moving unit away from or closer to said image capturing means, while the focus position of said image capturing means is kept fixed.

12. A foreign matter detecting system according to claim 2, further comprising an image-capturing-means moving unit capable of moving said image capturing means,
wherein said image capturing means captures the image at the focus position that is changed by moving a position of said image capturing means away from or closer to said container by said image-capturing-means moving unit.

13. A foreign matter detecting system according to claim 1, wherein said image processing means includes image failure checking means for detecting whether the taken-in image data is normal or abnormal.

14. A foreign matter detecting system according to claim 1, wherein said light source is an LED.

15. A foreign matter detecting system according to claim 1, wherein said image processing means has a terminal for outputting the image data taken in from said image capturing means on a display.

16. A foreign matter detecting system comprising:
a container capable of containing a liquid;
image capturing means disposed above said container and capable of capturing an image while changing a focus position;
a light source for emitting a ray of light to illuminate the focus position of said image capturing means; and
image processing means for executing image capturing control of said image capturing means and illumination control of said light source,
wherein said light source is disposed below said container,
said image capturing means captures an image while changing the focus position with respect to the liquid in said container, and
said image processing means takes in, from said image capturing means, image data of a liquid surface at the focus position of said image capturing means under illumination by said light source from below said container, and detects the presence of a foreign matter in the liquid based on the taken-in image data.

17. A foreign matter detecting system according to claim 16, wherein said light source is an LED.

18. A foreign matter detecting system according to claim 16, wherein said image processing means has a terminal for outputting a focus control signal to said image capturing means, a terminal for outputting an illumination control signal to said light source, and a terminal for taking in the image data from said image capturing means.

19. A foreign matter detecting system according to claim 16, wherein said image processing means has a terminal for outputting the image data taken in from said image capturing means on a display.
